(19) United States
(12) Patent Application Publication
(10) Pub. No.: US 2001/0029478 A1
(43) Pub. Date: Oct. 11, 2001

(54) System and method for supporting online auctions

(75) Inventors: Scott A. Laster, Snohomish, WA (US); Theodore A. Carroll, Seattle, WA (US)

Correspondence Address: Ronald M. Anderson, LAW OFFICES OF RONALD M. ANDERSON, 600 - 108th Avenue N.E., Suite 507, Bellevue, WA, 98004, US

(73) Assignee: Bidpath Corporation

(21) Appl. No.: 09/785,668

(22) Filed: Feb. 16, 2001

Related U.S. Application Data
(60) Provisional application No. 60/183,094, filed on Feb. 17, 2000.

(51) Int. Cl. G06F 17/60

(52) U.S. Cl. 705/37

(57) ABSTRACT

A system that facilitates bidding by online bidders in “live” auctions and provides enhanced functionality for administering auctions. Online bidders who are registered can select one or more “channels” to participate in auctions that are being held live for different collections of items. Data transferred over the Internet or other network is limited so that the asking bids, and current highest bid amounts can readily be transmitted to online bidders, who can then quickly respond with bids online, without slowing the bidding process for those bidders who are onsite. The system also provides management functions that facilitate the running of elections, including the registration process, compilation of inventories available for auction, and invoicing of successful bidders, both online and onsite.

### RELATED APPLICATION

This application is based on provisional application Ser. No. 60/183,094, filed on Feb. 17, 2000, the benefit of the filing date of which is hereby claimed under 35 U.S.C. § 119(e).

### FIELD OF THE INVENTION

This invention generally relates to auctions conducted both onsite and online over a computer network in multiple distribution channels, and more particularly, to a system and process for capturing auction inventory information, for distribution over a network such as the Internet, to facilitate electronic bidding and administrative activities typically associated with a live auction business.

### BACKGROUND OF THE INVENTION

Since the rise of auction-style commerce through the Internet, it has long been desired to provide a way to enable traditional auction-style businesses to easily and concurrently conduct their activity in both the traditional “onsite” manner and electronically through the Internet. Obviously, such enabling technology should not detract or otherwise negatively impact business conducted through the traditional process. Thus, existing solutions that require additional work to take pictures of items and match them with separately created records to capture information “online,” or which slow down or interfere with live “bid-calling” onsite, or which otherwise require additional work to accommodate back-end accounting and administrative processes are undesirable, and it would be preferable to develop new solutions that avoid these problems.

Integrating traditional onsite auction commerce with electronic-enabled commerce through the Internet involves four basic business processes. First, auction inventory information must be captured in a manner that accommodates both commerce methods. The capture of such information requires adding visual product representation to the traditional auction “catalog” of narrative item descriptions, since potential online bidders do not have the ability to directly view items at an auction site. Existing techniques include taking pictures with some form of camera and later attempting to manually match the pictures thus produced with specific description records of auction inventory, which can amount to hundreds or thousands of items and create significant additional work for the auction business. The second process involves integrating the existing onsite auction bidding with electronic bidding through the Internet. The prior art uses a system of proxy-bidders and technology that slows down the onsite bid-calling process. Additionally, registration of online bidders is not accommodated in any uniform or consistent manner, but should be to achieve the goal of creating a positive customer experience. The third process involves establishing electronic distribution channels for the auction product. Traditional auction businesses, and particularly, commercial auction businesses, typically handle a broad range of product categories at any given auction venue. Conventional methods attempt to channel this breadth of product into single distribution channels or Internet “web sites” and generally do not secure maximum exposure of the product offering to the most likely potential online bidders. The fourth process is the integration of the usual and customary back-end procedures, which are necessary to conduct an auction business. Existing auction processing systems today do not support full integration of dual commerce channels, and thus create additional work and hardship for auction company staff. It is therefore desirable to provide a technology infrastructure and business paradigm that enhances these four process areas as they relate to integration of Internet enabled commerce into the traditional auction business.

### SUMMARY OF THE INVENTION

In accord with the present invention, a method is defined for integrating online bidding over a communications network and onsite bidding at a location where an auction is being held. The integration is accomplished without requiring transmission of streaming video or audio data to online bidders from the location of the auction. The method includes the step of providing a database that includes information about items being auctioned. Prospective bidders who are online are then enabled to access the database over the communications network prior to entering a bid. Bidding information is communicated to and from bidders who are onsite at the location of the auction, and to bidders who are online, over the communication network. Bidders who are online are enabled to transmit bids to the onsite auction over the communications network. The highest bid is automatically determined from among bids made onsite and bids transmitted over the communication network by bidders who are online. A purchaser of an item being auctioned is thus determined based upon a highest bid made by a bidder who is either onsite or online.

The bidding information preferably includes one or more of an identification of the item currently being auctioned, an identification of any current highest bidder, an indication of any current highest bid amount, and an asking bid amount. Bids submitted by bidders who are online each include a bid amount, and an identification of the bidder who is making the bid.

The method also preferably includes the step of displaying (at the location of the auction) the current highest bid and an identification of the highest bidder, who is either online or onsite. Pre-registration of bidders who are online is another preferred step of the method.

Bidders who are onsite are also preferably enabled to enter a bid for an item electronically, e.g., using “a bid clicker.”

The step of communicating bidding information includes the step of transmitting packetized data over the communication network. Bidders who are online are enabled to participate in one or more of a plurality of auctions occurring on different channels accessible over the communication network, each channel being associated with a different set of items to be auctioned.

Also, the method further includes the step of providing a plurality of auction administrative functions in software used to integrate online bidding and onsite bidding. These auction administrative functions include one or more of: registering bidding participants in an auction; providing invoicing statements identifying each item purchased by a successful bidder in one or more auctions, costs associated with the purchase of each item, any adjustment to the costs, and a total amount due; accumulating data regarding bidders and items sold at an auction; and providing advertising that is displayed to bidders who are online.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a block diagram that shows the major components of a system in accord with the present invention;

FIG. 2 is a schematic diagram that shows the major components of an onsite portion of the system;

FIG. 3 is a schematic diagram illustrating a typical configuration of a “Web Farm” in accord with the present invention;

FIG. 4 is an exemplary home page for a web site that implements the present invention;

FIGS. 5A and 5B illustrate an exemplary registration page (top and bottom, respectively), which is accessed from the home page of FIG. 4;

FIG. 6 illustrates an exemplary bidding web page;

FIG. 7 shows a dialog box for entering a bid on the bidding web page of FIG. 6;

FIG. 8 shows an exemplary search results web page;

FIG. 9 is illustrates an exemplary onsite billing/invoicing web page;

FIG. 10 shows an exemplary onsite invoice corresponding to the web page of FIG. 9;

FIG. 11 shows an exemplary segment scheduling list;

FIG. 12 shows an exemplary user interface page for “tuning” a DSU to a particular channel;

FIG. 13 is an exemplary DSU channel set up page;

FIGS. 14A and 14B show an exemplary dense multiple listing mode of the DSU;

FIGS. 15A and 15B show an exemplary detailed multiple listing mode of the DSU;

FIG. 16 shows an exemplary single unit-listing mode of the DSU;

FIG. 17 shows a first exemplary view of a clerking interface;

FIG. 18 shows a second exemplary view of the clerking interface;

FIG. 19 show a third exemplary view of the clerking interface;

FIG. 20 is a list showing current high bidder information from the clerking station;

FIG. 21 is a list of scheduled upcoming items from the clerking station;

FIG. 22 is an exemplary list of measured round-trip times to various sites over a V.90 modem;

FIG. 23 is an exemplary partial calculation of the number of kilobytes per second over a V.90 modem;

FIG. 24 is an example of messages passing between the Internet system and the onsite system during a live auction;

FIG. 25 is an example of an extended markup language (XML) message envelope used in the message transport; and

FIG. 26 is an iteration of a prospective XML document type definition (DTD) for the communications between the Internet site and the onsite system.

### DESCRIPTION OF THE PREFERRED EMBODIMENT

The present invention is directed to a system implemented in hardware and software that can automatically control the bidding process of live auctions, manage the business operations, and link the live, onsite auction with participants on the Internet or other network. The high-level business requirements and functionality of this system, which should be enjoyed by a user, are listed below, from the highest to the lowest priority:

Provide the ability to bring web and onsite auction attendees into both live and silent bidding.

Provide the ability to harness the competitive “ego factor” for silent auctions as well as live auctions; this factor is the human characteristic that leads people to competitively bid the price up on an auctioned item, to win a bidding contest.

Provide the ability to manage auctions via simple computer interface.

Provide the ability to set up and use the present system with minimal technical expertise.

Provide the ability to catalog items in a format that “markets” the item instead of a stale listing.

Provide the ability to continue with an ongoing auction if the connection to the Internet system is lost.

Provide the ability to advertise good or services to attendees.

Provide t-auction business process functionality, such as registration, cashiering, clerking, and inventory management.

Provide the ability to export data and analysis t-auction business performance through the use of reports and other means.

In addition to these functions, a set of performance goals have been set for the present invention. These performance goals are:

Bidders should experience sub-second response on all transactions.

All displayed auction items should provide bidder and item status updates in less than 5 seconds.

Typical item queries should complete in less than one minute.

The system should scale to at least 150 simultaneous auctions initially, with no architecture impediments to scaling to 2,000 simultaneous auctions.

The present system is divided into three major portions. The first portion is the principle user's system that resides onsite for use by the present invention to facilitate auctions and to manage one or more ongoing auctions. The second portion is the Internet. (To simplify the following discussion, it will be understood that an alternative network can be used in the present invention instead of or in addition to the Internet.) The third portion is the pre-event set up of the system. The onsite system and the Internet share much of the business logic, database structures, and code. The present invention provides an innovative solution to the problem of integrating participation by online attendees in the onsite, live auction. Most prior art solutions to this problem involve some sort of audio or video streaming, which can create heavy bandwidth requirements and often lag behind the onsite event. The solution in the present invention is to use a highly optimized, low bandwidth capable data stream, to provide a much better buying experience for the online customer than has been achieved in the prior art.

Integrating the onsite processing into the system represents a significant innovation in the present invention. By providing a system that encompasses an auction company's current business processes, the present invention furnishes a solution that makes the processes of selling items on the Internet (or over another network) so easy, it is almost a side effect of the normal course of doing business for an auction company.

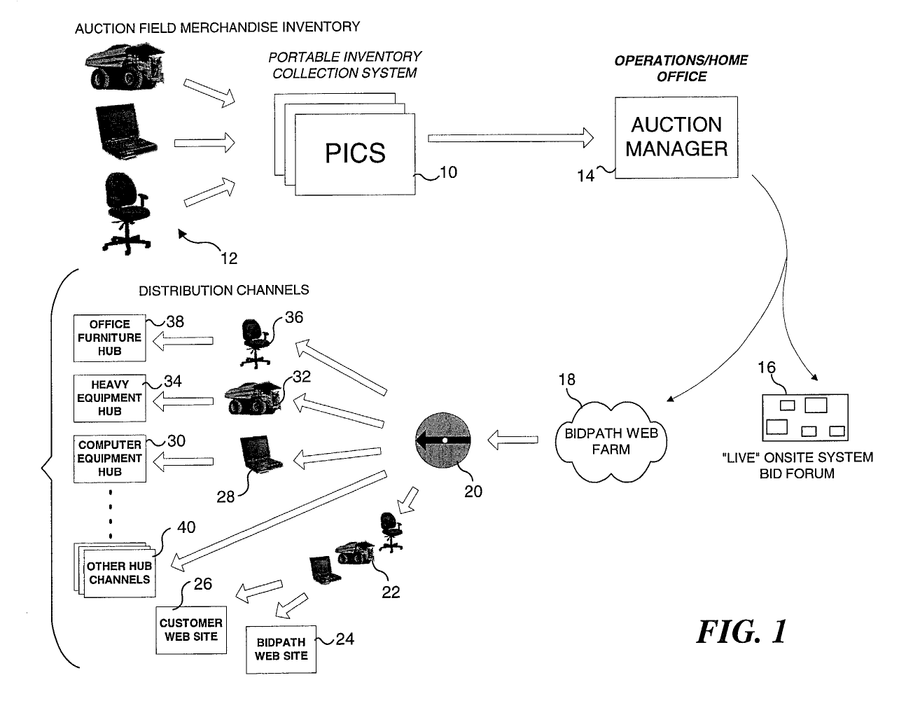

The system of the present invention has a number of different components, each designed for a specific purpose and catered to a particular role. The major components are shown in FIG. 1. A key component of this system is a portable inventory collection system (PICS) 10. The PICS system is a multimedia inventory collection system that executes custom software to guide the user through the process of creating quality pictures, voice recordings, and other data that is later displayed to both Internet and onsite bidders. Details of the PICS system are disclosed in commonly assigned U.S. patent application Ser. No. 09/742,146, filed Dec. 20, 2000 and entitled Method and System for Collecting Rich Inventory Via a Computer System,” the drawings and specification of which are hereby specifically incorporated herein by reference. The PICS system makes sure that all the pictures, voice recordings, and all other data pertaining to an item are kept together throughout the system so there is no confusion about which picture, voice recording, and data correspond to a specific physical item in an inventory of items 12 to be sold at one or more auctions.

The present invention employs guided capture to assist users in capturing pictures, assigning categories, providing audio description, pictures and other data, and associating the data together to represent the items to be auctioned and represents a novel approach to the problem of inventory data collection. In particular, this approach eliminates the need to sort pictures and transcribe handwritten data. An Auction Manager 14 includes software employed to import data from the PICS system and enables the user to correct and supplement the data collected in the field by examining the pictures, voice recordings, and other data collected.

The present invention also provides innovative ways for users to access the system both at a “live” onsite system bid forum 16 or by connecting to a Bidpath Web Farm 18 through Bidpath Corporation's web site 24 or a customer web site 26 to access any of items 22 that are being auctioned. As will be apparent from the following description, users can access the Bidpath systems in ways not considered or provided by conventional online auction companies. A channel selection 20 also enables a user to select a desired distribution channel, such as a channel 28, which offers computer equipment through a hub 30, or a channel 32, which offers heavy equipment through a hub 34, or a channel 36, which offers office furniture through a hub 38. These channels are exemplary, since many other types of channels can be made accessible through hubs 40.

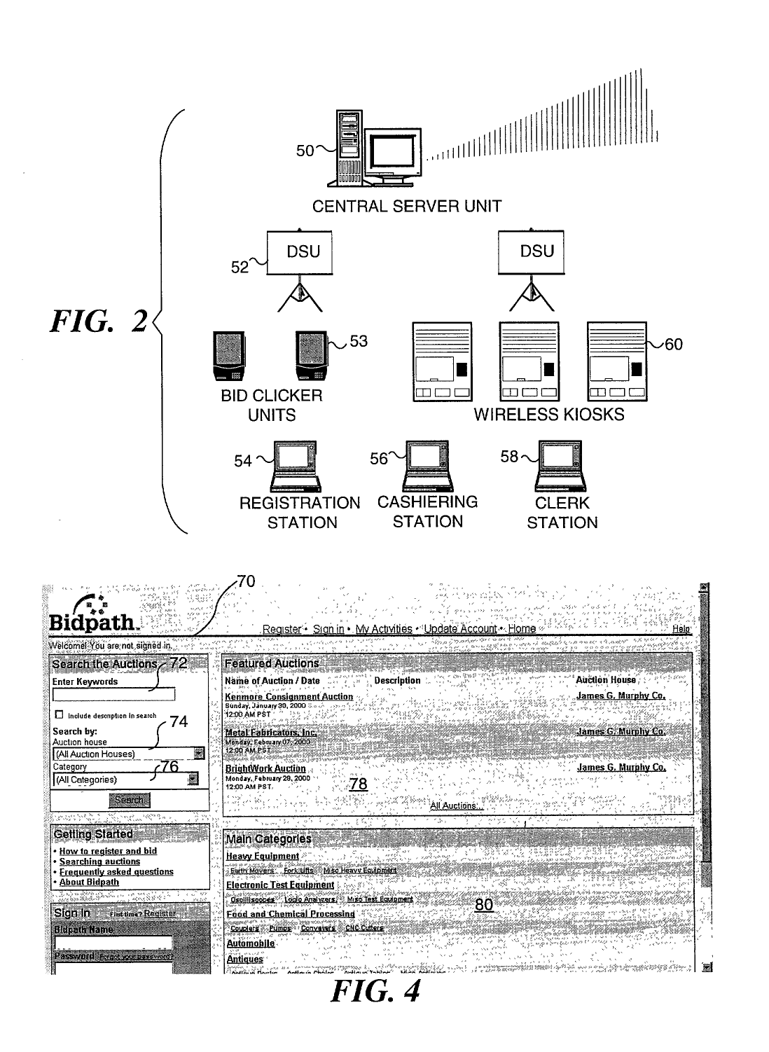

As shown in FIG. 2, a central server unit 50 is part of the present invention and implements the logic that coordinates an ongoing auction as well as serving the data required to operate the other components of the system. This server preferably runs Microsoft Corporation's Windows NTTM or 2000™ operating system software, SQL Server 7™, and Internet Information Server (IIS).

A display server unit (DSU) 52, which is also a component of the present invention, drives a data projector and provides feedback to auction attendees, including current bid amounts, highest bidder, current item(s), upcoming items, announcements, and advertisements. Wireless bidding kiosks 60 enable onsite bidders to interact with an ongoing auction. Through these wireless kiosks, attendees can preview upcoming items, bid, and check the status of items currently being auctioned.

A clerking station 58 is staffed by a person who takes deposits, distributes bidding paddles, bid clickers, and access cards. There may be multiple registration stations 54 in use at an auction, or these stations may be combined with a cashiering station 56. The invoicing/billing cashiering station enables a cashier to prepare and print invoices and collect payment for items purchased at the auction. There may also be multiple cashiering stations in operation at a particular event, depending upon its size and attendance. A clerk is responsible for recording current bids from a live auction and posting them through this cashier station. The system will update both the Internet site and onsite displays. The clerk is also responsible for keeping a current item, as seen by the electronic system, synchronized with what is actually happening in the live auction. Bid clicker units 53 enable an attendee to bid on items without visiting a bidding kiosk. The bid clicker unit permits a bidder to submit incremental bids as well as a jump bid (a bid that exceeds the current asking price for an item).

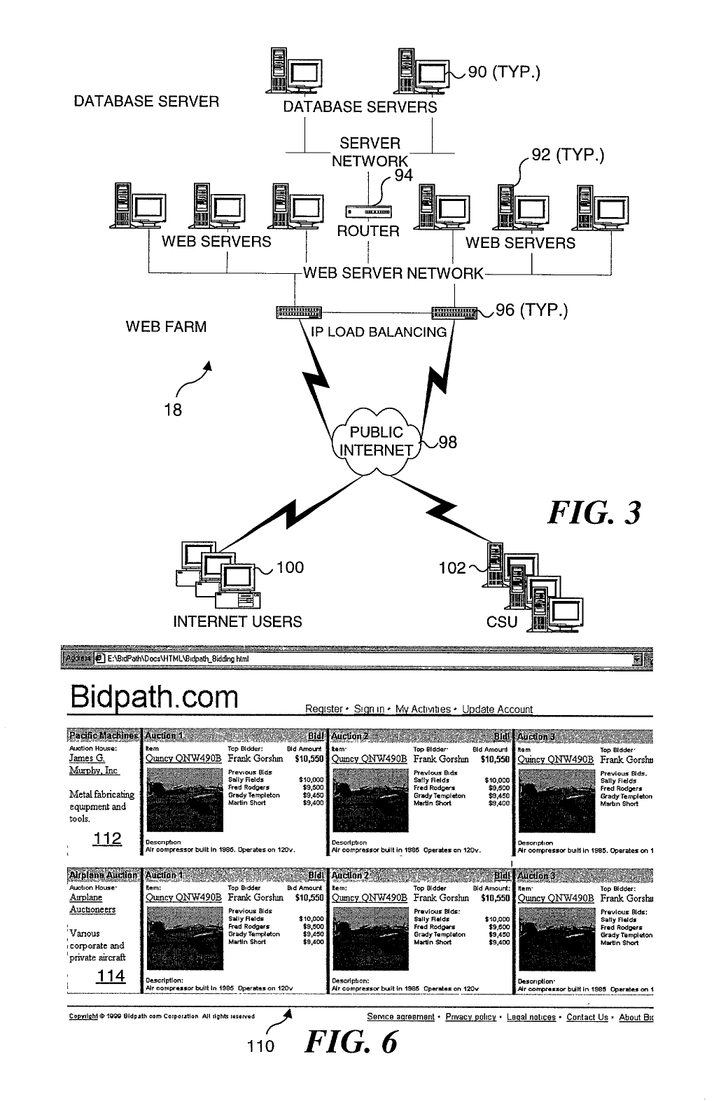

The Internet enables a user to interact with ongoing auctions on the user's computer—at home or elsewhere. The Internet, which is indicated in FIG. 3 at reference numeral 98 communicates with the onsite system through the exchange of XML messages using hypertext transport protocol (HTTP). HTTP was chosen because many of the systems with which the present invention is used will likely be permanently installed at auction houses, which have an existing Internet connection with a firewall in place. Using another protocol to communicate with the Internet could cause administrative problems for system administrators who would have to reconfigure a firewall.

Generally, the idea behind web farm 18, details of which are shown in FIG. 3, is that most of the central processing unit (CPU) intensive operations involve formatting the data from the database and managing the communications to the Internet client. By using an arrangement of database servers 90, web servers 92, one or more routers 94, and Internet Protocol (IP) load balancing, as shown in FIG. 3, it is possible to spread the load over the multiple servers, thereby eliminating the web server as the scalability bottleneck. In a typical web farm, a specialized computer or hardware 96 handles IP load balancing. Essentially, this specialized interface takes an incoming request and routes it to one of many web servers 92 running on a private web server network. All of these web servers are configured with identical software so that the entire network of web servers appears as one very fast server to Internet user computers 100 and to channel service units (CSUs) 102 that are connected thereto over the Internet. Typically, more than one load-balancing box is used, so that if one fails, the other can take over.

The biggest issue in programming for web farms is what has been termed “persistence.” For maximum scalability and availability, the individual web servers must maintain no states. All states must be passed down to the client via HTTP cookies, which are temporarily stored in a database on each user's computer. If this is done, a user can be transferred to various web servers without having to continuously return to the same one. Because the user can move between servers, there are no ill effects if any one server is too busy or fails.

In developing the present invention, an attempt was made to coalesce actual interactions and experiences with customers into a series of roles. Each role may be filled by one or more people involved with the system of the present invention, or a single person may fill multiple roles. It is important to build a profile of each role so that typical users and their abilities and preferences can be considered in the design of the system implemented in the present invention. The following is applicable to the present invention:

Role Name: Administrator

Core Expertise: Auction Set up/Coordination.

Technical Ability: Basic Computer Operation; should be familiar with database applications and office productivity software.

Tolerance to Change: Should be somewhat tolerant to change, although any system that increases the amount of work required to set up an auction will be resisted.

Attention Span: Typically will be very busy, with little time to learn a new system, but a system that provides compelling advantage will be accepted. Some individuals in this role may be interested in technology, but the majority will be looking to get their jobs done as quickly and efficiently as possible.

This person will be responsible for setting up the existing hardware and cashiering stations, and may already be responsible for other tasks, such as running the registration table. Will likely take on some new responsibilities as a result of the system. Most likely, will be responsible for the scheduling and DSU set up in addition to the set up of the hardware in preparation for an actual auction. This person may also coordinate any communications needs for the site including Internet service provider (ISP) and telephone company selection, which may require some additional technical skills.

Role: Cashier

Core Expertise: Running cash registers, data entry.

Technical Ability: Minimal to low technical ability is required; does not necessarily have extensive computer experience, but does know how to use a cash register.

Tolerance to Change: Will likely have low tolerance to change; the software must be easy to learn.

Attention Span: Cashiers can be very busy during the auction and need software that they can use quickly. It must be intuitive and provide immediate feedback, when appropriate.

This person is responsible for entering invoice information for customers and will receive high bid information from the auction clerk. In some cases, this information may currently come on slips of paper. The information identifies the high bidder, the item purchased and the winning bid amount. All items purchased by a particular customer need to be assembled and totaled. Taxes and any auction premiums are added. Any deposits are subtracted and the total due is presented to the customer. The cashier takes and records payments. Credit cards need to be verified. An invoice and/or claim tickets are printed for the customer.

Changes Required: The cashier will be required to learn new software. However, the software provided for the present invention will automate much of what was previously required to be done manually by the cashier and will eliminate areas prone to human error. The invoice can automatically be assembled from data entered by the clerking software. All calculations will be complete. The cashier will need to call up the customer's invoice, take and record payments and issue invoices and/or claim tickets.

Role: Registrar

Core Expertise: Data entry.

Technical Ability: Requires minimal to low technical ability; however, the registrar must be familiar with spreadsheets and other office administration software.

Tolerance to Change: Likely to have low tolerance to change; the software must be easy to learn.

Attention Span: Registrars can be very busy during the auction. They may have time to learn the software prior to the auction, but they can not learn it on the job. They need software that they can use quickly, and it must be intuitive and give immediate feedback when appropriate.

This person is responsible for manning the entrance to the auction, greeting attendees, registering them, calculating and taking deposits (when needed), and handing out paddles and auction catalogs. If time permit, the registrar answers questions for novice auction attendees and puts them at ease. The registrar may comment to regular customers on auction items in which they would be interested.

Changes Required: The registrar will be required to learn new software in accord with the present invention, but use of the software will probably not be a drastic change from the current method of registration. However, it cannot be more difficult to use and should be an obvious improvement to make learning it worthwhile.

Role: Clerk

Core Expertise: Each clerk knows the customers and will likely have two or more customers to please. For example, Customer 1 may be an individual or organization that wishes to unload items, while Customer 2 wishes to pick up items. The clerk is primarily interested in keeping Customer 1 happy, and to a lesser extent, must also keep the other buyers who participate in the auctions happy.

Technical Ability: None assumed.

Tolerance to Change: Will prefer not to change the way that business is done, but will realize that change may be required.

Attention Span: Needs to concentrate on the action of the moment—not the software. The software has to be very easy to use. A clerk will be primarily interested in the item currently being sold, and in the next item to come up on deck.

The clerk is the linchpin of a live auction. Without the clerk's careful machinations, the entire auction could dissolve into chaos. It is the clerk's responsibility to oversee the activities of the bid caller and the ring men. The clerk will be primarily concerned with keeping the auction organized and on track, ensuring that lots are processed in an appropriate time and finished when appropriate. It is also the clerk's job to ensure that bidders are able to cover their bids and to act as a money man.

Changes Required: A private display will be provided by the present invention to keep the clerk better informed of bidding progress, as well as the overall auction schedule and details of the lot currently being sold. The user interface should be very simple, so after a small period of adjustment, the clerk will be much better informed and in control of the auction than in a conventional auction.

Role: Bid caller (a.k.a., auctioneer)

Core Expertise: Generally a fast-talking entertainer type, facilitator, and manager. Good event management skills are needed to move things along in a timely manner.

Technical Ability: None expected. Typically, auctioneers have grown up in a family business, rather than graduating from a specific degree or trade program. Although the auctioneer may be very intelligent in areas of endeavor that matter to him, he should be expected to deal best with a simple user interface into the software.

Tolerance to Change: In the beginning, may be somewhat intolerant, probably in direct proportion to a fear that technology will soon drive the auctioneer out of business. May be reluctant to embrace new ways of running traditional auctions, but will likely accept change that will increase the chances for professional survival. It will be important to convince the auctioneer that those same changes will both make life easier and increase income, so that any original reluctance may lessen over time.

Attention Span: Likely to be very short. While conducting an auction, this person can not even afford to talk slowly, but instead, must think very quickly and is not likely to be tolerant of any new task requirements perceived as getting in the way of the auctioneer's primary task.

Short Job Description: Bidding facilitator, marketer. Promotes interest, assesses the degree of interest among bidders and the amounts that they will be willing to spend. Decides when to quit asking for more money for the current item and move on to the next item.

Changes Required: The present invention will provide the auctioneer with a private display that displays information on the bidding progress, as well as a large display unit that others can see. In accord with the present invention, the auctioneer will have bids arriving from online bidders as well as the traditional onsite bidders. Also, there may be ways to take advantage of an additional source of bids, fostering more competition between the traditional onsite bidders and Internet bidders.

Role: Collections

Core Expertise: Cashiering.

Technical Ability: Must be capable of basic computer operation and have familiarity with spreadsheet and/or custom desktop software requiring user input.

Tolerance to Change: Likely to be moderate, since this user is already tracking bidders and their purchases with a manual or computerized system. There will be resistance to a new system if it involves more effort and/or time than the current conventional system.

Attention Span: Very limited. This user must be able to quickly and efficiently find information about bidders and settle their accounts. The system of the present invention must be very easy for this individual to use with a minimal effort.

Responsible for settling transactions with auction attendees who have made winning bids on items. This person may also be involved with collecting and returning monies used for collateral.

Changes Required: Basic responsibilities should not change. Primary change will involve the method used for tracking auction attendees and their winning bids.

Role: Fulfillment

Core Expertise: Merchandise Delivery/Customer Service

Technical Ability: Knowledgeable of basic computer operation. Familiar with spreadsheet and/or custom desktop software requiring user input.

Tolerance to Change: Likely to be moderate. This person is probably using a simple inventory system at present. Any new system for tracking inventory deliveries will also need to be simple and efficient.

Attention Span: Very limited during the auction. More attention can be applied to the system at times when the auction is not in progress. This person is busy arranging for the retrieval of items to be hand delivered at the auction site, and for items to be delivered off-site by some other means.

Arranges for delivery of items to winning bidders having settled their accounts.

Changes Required: Basic responsibilities should not change; primary change when using the present invention will involve the method used for tracking delivery of items to customers.

Role Name: Collection Bidder—any type of merchandise/services offered.

Core Expertise: Variable.

Technical Ability: May have a range of technical ability, from no computer skills to that of a computer industry professional.

Tolerance to Change: May be willing to change if it will benefit collections. The technology provided by the present invention should not get in the way of this person's hobby, however. It must add value over the current collecting methods.

Attention Span: Collectors are willing to spend time on their collections, because their hobby is something that they currently enjoy and give much of their attention.

Changes Required: The software of the present invention will particularly benefit collectors by identifying their collection interests so that they can be informed of upcoming auctions that pertain to their interests. Online auctions will require collectors to learn new software, but will give them access to far more items than local auctions.

Role Name: Charity Bidder

Core Expertise: Variable.

Technical Ability: May be a wizard with a remote control.

Tolerance to Change: Since a charity auction is a social event, this type of person would not mind checking out new ways of doing auctions. As long as the new system provided by the present invention is presented as “fun” and so long as it livens up the evening, this role type will likely be all for it.

Attention Span: This person's attention is split between attending social events and ensuring that her/his name shows up on the bidding board.

Changes Required: The Charity bidders will almost always be bidding in person, so they will need to learn how to use kiosks and/or handheld units to benefit from the present invention. In addition, they will derive satisfaction from the display server unit as their venue for providing public recognition.

Role Name: Internet Bidder

Core Expertise: Various.

Technical Ability: At least capable of personal computer operation. Uses browser software and modem/LAN to visit Internet sites.

Tolerance to Change: Varies with individual. The range is between those already using Internet auction sites and those with little or no experience in using computers.

Attention Span: Moderate for average Internet user. Those who regularly attend live auctions will be accustomed to a period of waiting. Regular Internet users may be less tolerant of delays.

Changes Required: Users familiar with live auctions will need to adjust to a new system for inspecting and bidding on items. In particular, the pace and style of bidding will be different from the typical live auction, when employing the present invention.

Professional auction houses will be able to use the Internet site on which the present invention is implemented, in conjunction with the system that implements it, to include bidders not physically located at an auction site.

Internet users visit this web site to preview and/or bid on items using web pages that display information about upcoming auction events, items to be auctioned, and auctions in progress. A registration and logon feature allows the Internet bidder to make secure bids on items. Registration also provides auction houses with information they need to conduct their business. Auction houses “publish” their auction events and items with facilities provided by the system that implements the present invention.

The Internet site on which the present invention operates serves Internet bidders, auction houses, and advertisers through implementation of the following functional areas:

Registration and Logon

Instructions and FAQs(Frequently-Asked-Questions)

Auction Previewing

Bid Agents

Live Bidding

Notification

Monitoring of Bidder Activity

Advertising

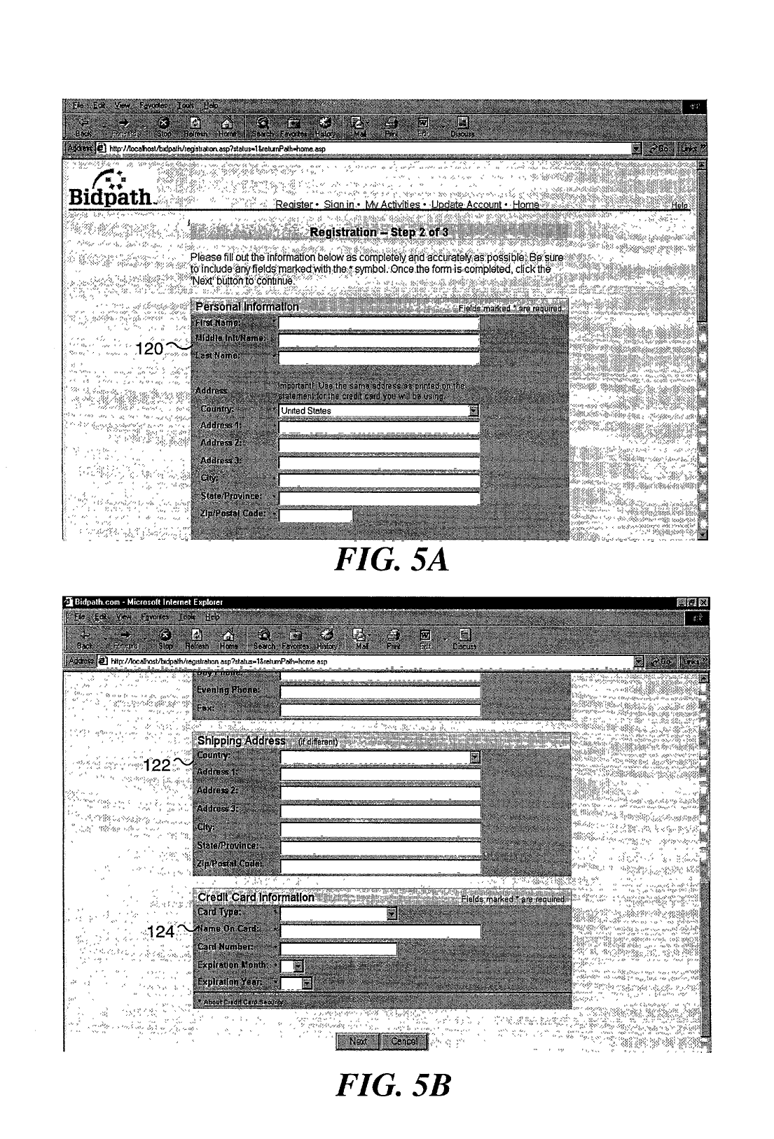

In order to place a bid, visitors to the site must be registered and logged on to the system. When the present invention is initially implemented, the logon will be on a web site identified by the Internet URL address www.bidpath.com, operated by Bidpath Corporation, which owns the present invention. For convenience, and to encourage the user to logon, every page at the site will have a Register/Logon section or link, like that shown in FIGS. 5A and 5B. Registering is not required, however, to view upcoming auctions, items, or live bidding. When registering, the user will enter personal information (name and address) in a section 120 of the registration form, and complete a shipping address section 122 and a credit card information section 124 on the registration form.

Registration allows a user of the present invention site to uniquely identify themselves with a username and password. Additional information, such as first and last name, billing and shipping addresses, and credit card information, is also collected as part of the registration process.

Once a potential bidder has registered, he or she can log on to the system by simply entering a username and password. For convenience, the username and password can be automatically remembered by the system, e.g., using “cookies” stored on the user's computer.

New visitors to the site will likely have questions about how to go about the business of previewing and bidding on items. Links with appropriate titles such as “How do I place a bid?” will be prominently displayed on various web pages, including the home page. A page or set of pages with FAQs will enable users to get answers to most of their questions and put them at ease with the idea of bidding online at Bidpath Corporation's site.

Upcoming auctions are listed with a title and event date/time in ascending chronological order. A summary of the auction type, location, and a few featured items are presented in the list. A potential bidder views the list and clicks on an auction title to begin previewing items for that auction. The items are presented as a list, with thumbnail images if available, and a description, as shown in an exemplary bidding web page 110 in FIG. 6. Estimated values for each item is shown if available. An expanded description and/or enlarged image is available by clicking on links associated with each thumbnail image in the bidding page.

Large lists of items and/or services for auction are presented as separate pages with navigation buttons/links provided. Also, entering keywords into a search box 135 can restrict a list of items, as shown in an exemplary listing web page 134 in FIG. 8. When searching, the user has a choice of whether to include the description text in the search. The exemplary listing includes items 136, 138, 140, and 142.

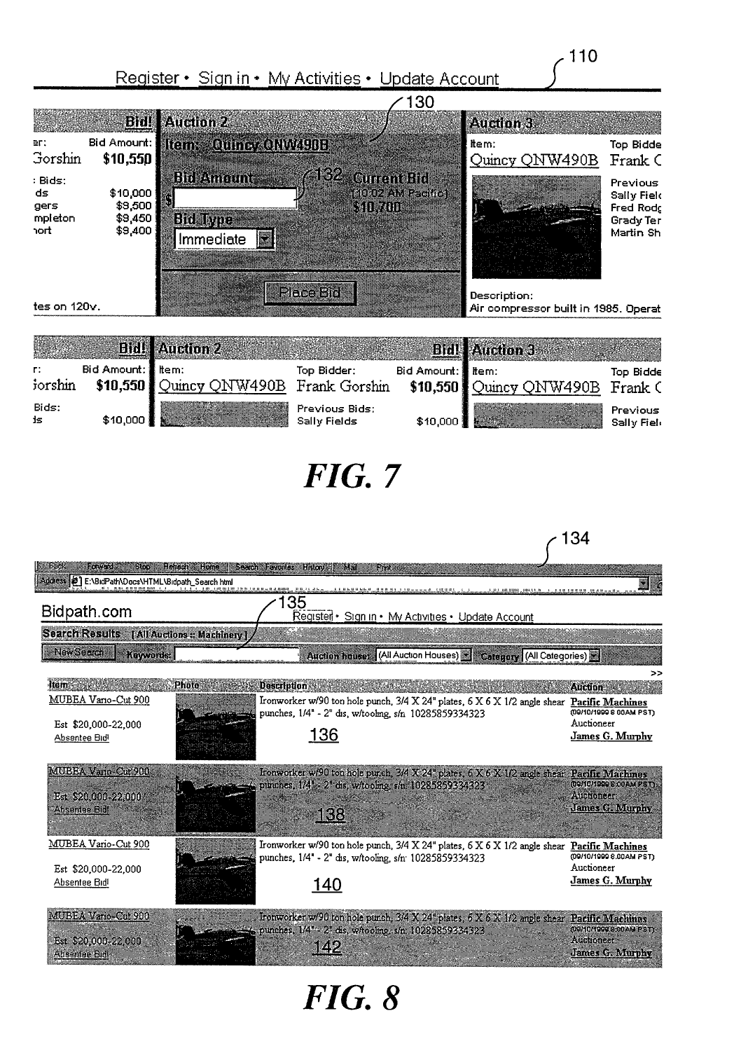

When logged on, a user may click on a link next to an item being previewed and place an absentee bid by entering a bid amount and choosing a Bid Agent. FIG. 7 illustrates a dialog box 130 that includes an entry box 132 for entering a bid on the item selected from exemplary bidding web page 110 that is illustrated. Bid Agents enable a bidder to place an absentee bid. Bid Agent bidding for an item is permitted both before the auction takes place and until the closing bid on that item. It is contemplated that the user will be provided with different types of Bid Agents for various bidding strategies. The primary Bid Agent will enable the bidder to place a maximum bid amount.

On any given day, one or more auctions may be in progress. The Bidpath Internet site lists the auctions that are in progress, and as also shown in an exemplary web page 70 in FIG. 4, lists those that are upcoming in a section 78 of the web page, enabling the bidder to select one or more auctions to monitor. A section 80 on this web page lists the main categories of merchandise or services that are being offered at auction. A text entry box 72 is provided to enable a user to enter keywords to search for items being offered at auction, and the user can optionally select a specific auction house in a drop down box 74, or a specific category in a drop down box 76. Only logged on users are allowed to actually bid; they may register and/or log on from the page that monitors live auctions.

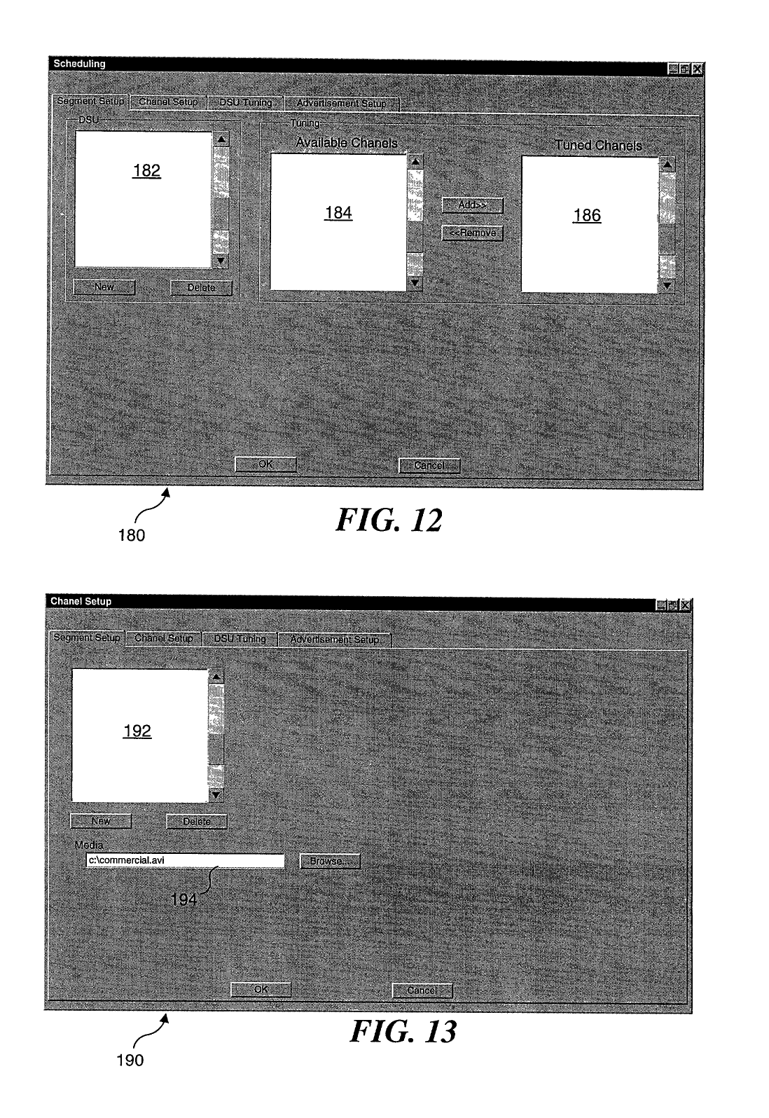

An auction site may schedule more than one item/lot for simultaneous bidding. Because of this, each monitored auction site presents a separate channel to view the bids as they occur. As shown in a dialog box 180 in FIG. 12, a user can tune in a desired channel from among those listed in a block of tuned channels 186 to participate in an auction. A section 182 lists the DSUs available and a block 184 lists the available channels that can be selectively added to the list of tuned channels. Each channel that is tuned will also display the next few items/lots in the queue with links to information about those items. When viewing the item(s) in the queue, the bidder may use a Bid Agent to place a bid if desired.

A bid may be entered for any channel displaying active bidding for an item/lot. Should a bid be highest when the auction site receives it, the bidder's name will be displayed in the channel as the highest bidder. The most recent bidder names are displayed, with the current high bidder displayed at the top.

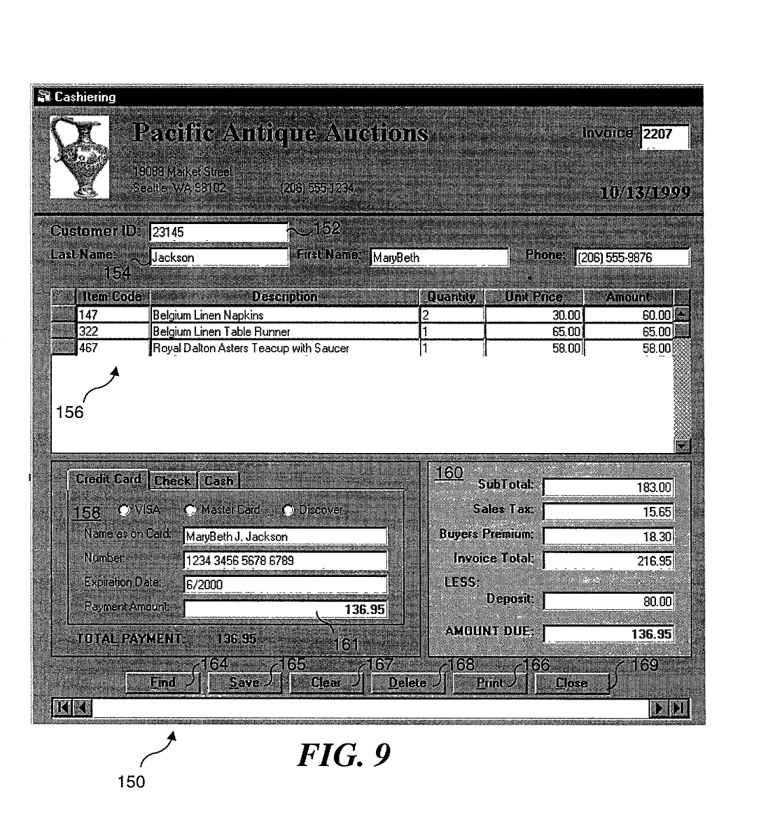

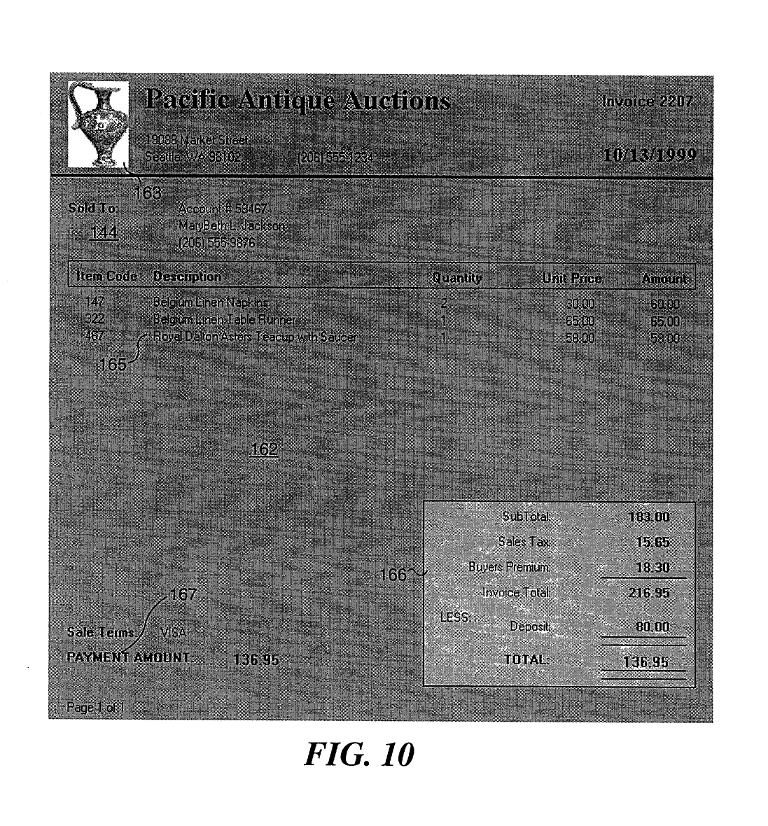

Users of the site may wish to be reminded via email when a particular auction is about to begin and simply click on an image associated with an auction to be notified a few days in advance of its occurrence. Users may also be notified of upcoming auctions of a particular type or those containing certain items or categories of items. Notifications of winning bids are also sent to the user, along with an invoice 150 for any item(s) won at the auction, as shown in FIG. 9. This invoice includes a customer ID 152, a name 154, a list 156 of the items won by bidding, credit card data 158, and invoiced data 160 that lists the subtotal, taxes, deposits, other adjustments, and the amount due. For attendees of a live auction, a printed invoice, an example 162 of which is shown in FIG. 10, will provide substantially the same information.

Whenever a user places a bid, either live or through a Bid Agent, it is added to the bidder's activity log. This activity can be viewed at any time by clicking on a link to show their activity. The status of each bid is presented in a list. The bidder may remove any aged bids from their activity listing.

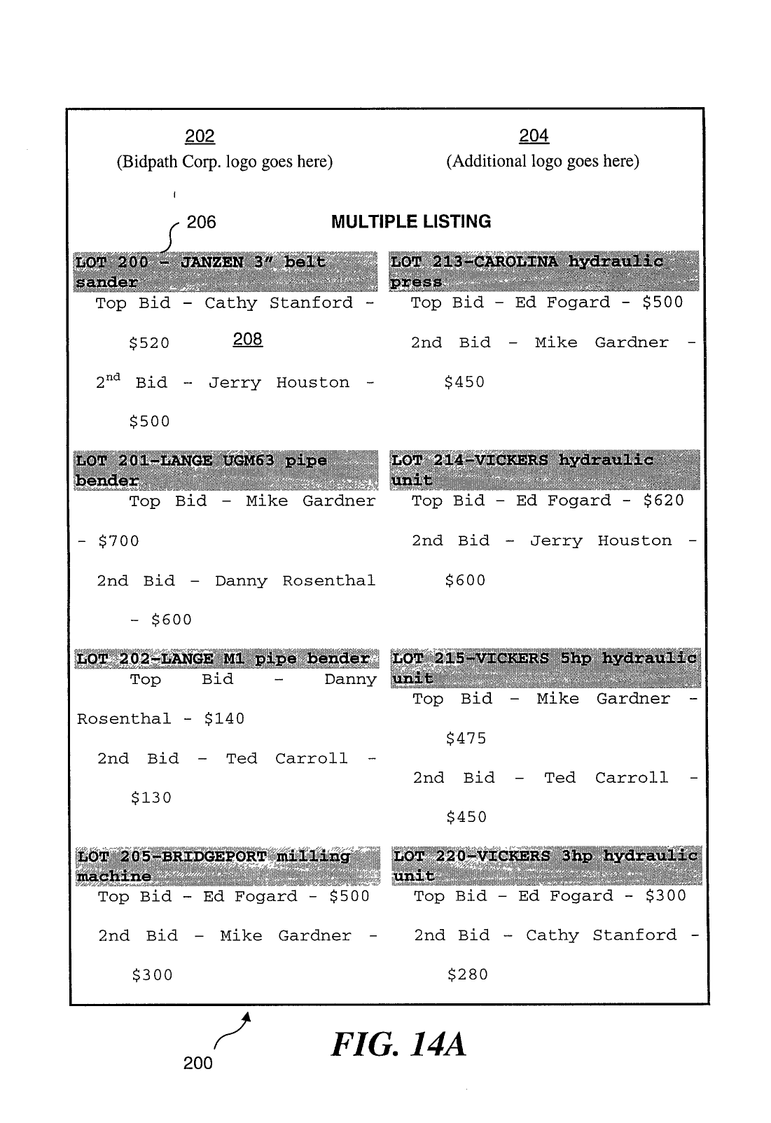

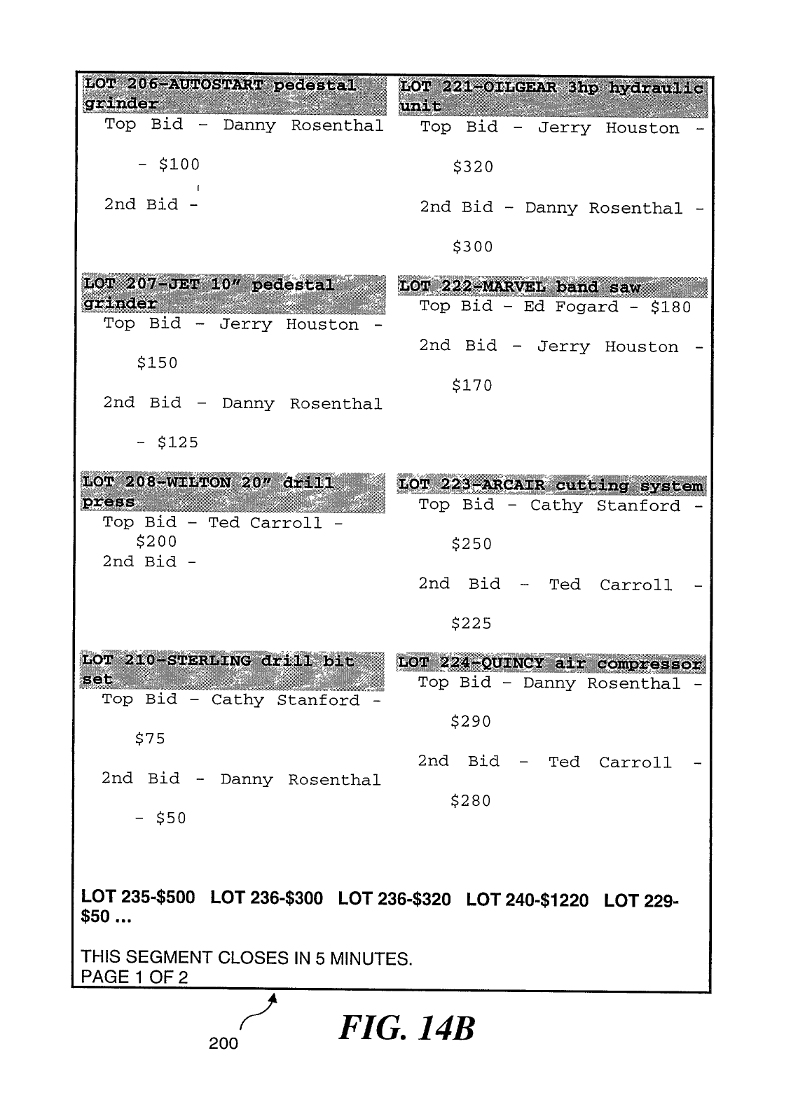

The Bidpath web site may optionally contain ad banners. These banners would typically be placed near the top of the web pages 200 (as shown, for example, at locations 202 and 204 at the top of FIG. 14A). As indicated in FIGS. 14A and 14B, the following information is displayed for each lot in a segment:

A lot number and short description of a lot 206; and

The top two bids on the lot, including bidder and bid amount (in a section 208).

Note that items with no bid next to the second bidder's entry have only had one bid on them so far.

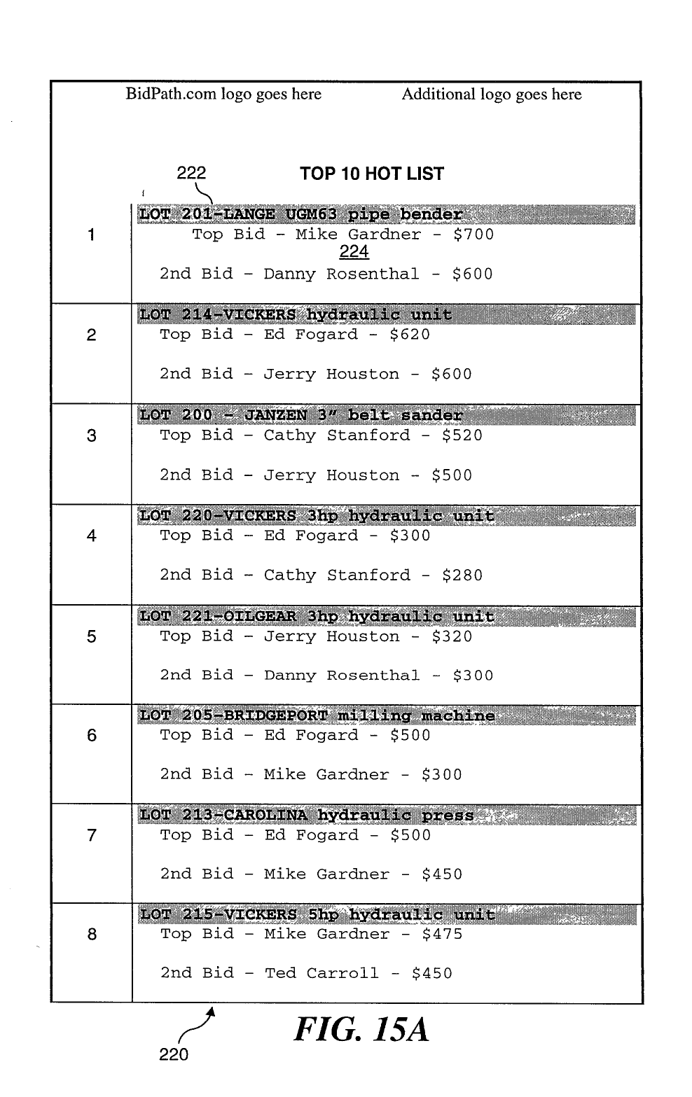

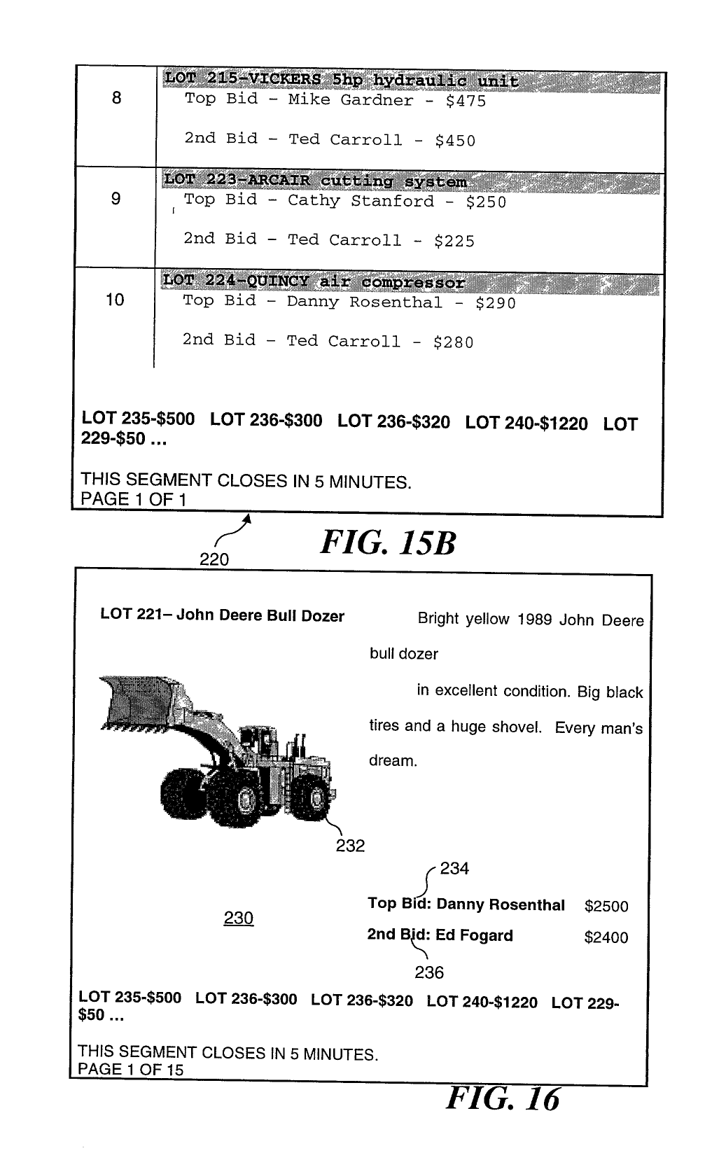

The hot list mode, an example of which is shown in an exemplary web page 220 in FIGS. 15A and 15B, displays information 222 about the 10 lots in the current segment that are being bid on most actively over a given period of time. The user specifies the time to be used to calculate the statistic, as well as the frequency with which it should be recalculated. For example, the user might specify to rank the items according to the number of bids over the most recent two minutes, with the rankings being recalculated every 10 seconds. Thus the rankings would be updated every 10 seconds, showing the most actively bid items over the most recent two minutes.

The Bidpath web site will also enable vertical distribution partners to incorporate content, listings, and transaction engine into their sites. The Bidpath site enables vertical market partners to do this in two ways. First, Bidpath provides web site morphing technology that enabling the Bidpath web site to take on the appearance of a vertical partner's web site, so that the partner can incorporate the web site into a frame on its site. With the website morphing technology, the end user has a consistent user experience with the Bidpath web site appearing to be an integrated part of the vertical market partner's web site.

The second mechanism is an XML application program interface (API) that enables the vertical market partner to send requests for actions, such as user registration, bidding, and others to the Bidpath web site in order to utilize Bidpath's content and transaction engine without using the Bidpath user interface, thereby enabling the vertical market partner to have complete control over the user experience, while still using the content and transaction engine of Bidpath. The Bidpath web site also enables users to access the content and transaction engine through wireless web technology through the wireless application protocol (WAP).

The purpose of a registration station for users participating in an auction is to set up a customer account with the auction house. The software provided in the present invention to do registrations will obtain the following information:

Name and Billing Information;

Optional Shipping Information;

Optional Credit Card Information;

Optional Deposit;

Optional Marketing Information; and

Add new accounts.

The software of the present invention provides the following functionality:

Associates new and existing accounts with the current auction;

Allows modifications to customer accounts;

Allows the removal of customer accounts; and

Take deposits, if required.

The database objects potentially accessed by the registration station are:

Bidder;

Address (ShipTo and BillTo);

Card;

CardType;

Deposit; and

DepositType.

Registration will obtain vital information from a potential bidder to authorize the bidder to participate in the current auction. Different auction houses may require different information. For example, some auctions may require a deposit prior to bidding at that particular auction. The registration software can also be used to gather marketing data on the bidder. This information can be used to target customers for mailings regarding upcoming auctions. The items that show on the registration screen can be customized prior to the auction, to meet the requirements for that auction and that auction house.

Once a customer has been registered for any auction using BidForum, they do not need to go through the entire registration process again. However, they must sign in to each auction they attend, but the registrar will simply lookup the customer's registration information, verify it with the customer, and instantaneously sign the customer into the auction. In the case of an auction that requires more information than is currently available for the customer, the registrar will only need to fill in any missing fields. For example, one auction house may require a driver's license number not previously obtained from the customer, which must be added to the customer's registration information.

The following section describes in detail the user interface of the software at the registration station. The registration station is staffed throughout an auction. As attendees arrive, they must register prior to bidding on items. The registrars are not necessarily computer literate and are required to register people quickly, particularly at the open of the auction.

The registration station software component of the present invention is easy to learn and use. It gives immediate feedback on any erroneous entries. Required fields are clearly marked so that the registrar does not accidentally skip them when reviewing the registration form.

The Registration form is split into several sections, generally the same as described above in regard to the online registration form of FIGS. 5A and 5B. There will always be standard customer information that includes the Name and Address. Optionally, depending on the auction, there may be a Shipping Address, Credit Card, Deposit, and/or Auction Interest Section. The list of valid credit cards, as well as the method of deposit calculation will be displayed dependent on data provided by the auction house. The initial registration form comes up blank. The action buttons are clearly displayed at the bottom of the page.

After filling out a customer ID, or a customer name, the registrar selects FIND. The entries are used to search for that customer's account in the Bidpath database. If a match is found, the registration form will be automatically completed with the customer's information. At this time, the registrar can verify the information with the attendee. If all required fields are completed, and the information is correct, the registrar simply selects SIGN IN, and the registration is complete. If a match is found of the attendee in the stored information, but required fields are missing, the registrar will ask the customer for the missing information and select SAVE to update the customer account and complete registration.

If no match is found for the customer, NEW is selected to create a new account. Selecting NEW clears the registration form and automatically assign a Customer ID. The registrar fills out all required fields with information obtained from the customer. Optional fields are entered as appropriate. Selecting SAVE will complete the new registration. Selecting CLEAR clears all fields in the form, including the customer ID.

To remove a customer entered erroneously, DELETE is selected. Verification is required prior to the delete action being completed, since the customer will be deleted from the database by this action. If the data for the customer has not yet been sent to the database, it will not be sent once DELETE is selected. The registrar selects CLOSE to shut down the registrar window and return to the main Bidpath forum on the web site. Either ENTER or TAB is selected to move to the next field on the form. The tab order will follow the natural flow of the fields.

Auction information is associated with a customer in Bidpath's database each time a new customer account is created or an existing customer signs in, enabling an auction house to track the times a customer went to an auction and determine what kind of auction was last attended. This information is useful for informing active customers of upcoming auctions, which they might be interested in attending.

The purpose of the cashiering station is to produce invoices for auction customers and to record payments for goods purchased. The cashiering software must:

Create invoices for customers;

Access highest bid information linking customers to items purchased;

Calculate totals, taxes, fees and payment due on invoice (accounting for deposits);

Allow modifications/corrections to invoices;

Take payments (record credit cards and/or checks information); and

Print invoices to be used as receipts and claim tickets.

The database objects accessed by the cashier are:

Bid;

Bidder;

Address (BillTo);

Invoice;

InvoiceItems;

Item;

Card;

Card Type; and

Deposit.

Cashiering assembles an invoice like invoice 162 in FIG. 10 for a particular customer that itemizes all goods purchased by that customer. The invoice will summarize totals for the items, adding in taxes and any buyer's premiums; it will also account for any deposit already made by the customer. The final Amount Due will be calculated.

Invoice construction occurs automatically. The auction clerk will have already recorded the high bid amount and the high bidder for each auction item. All winning bids made by a particular customer are therefore easily automatically assembled from the database into a single invoice for that customer. This item information includes the item number, brief description of each item, number of units purchased, and the high bid amount. Totals are calculated for each item, and then summary totals are calculated across all items. Taxes and buyer's premiums are added, and deposits are subtracted. The final amount due will be presented to the customer on the invoice.

The cashier's job is to collect payment from the customer. Auction houses may allow different payment terms. The cashier's invoice form can be customized to prompt only for that auction house's choices. The payment is recorded, and then the invoice is printed out to serve as both a receipt and a claim ticket.

The following section details the user interface of the software for the present invention at the cashiering station. The cashiering station is staffed throughout an auction. Attendees will make payments prior to picking up purchased items. The cashiers are not necessarily computer literate; however, they are required to take payments quickly.

The cashiering station software is easy to learn and use, and will give immediate feedback on any erroneous entries. The invoice creation is automated so the form will be completed automatically, but cashiers are nevertheless given the ability to modify the form fields in case any corrections need to be made.

The cashiering invoice form is split into several sections, generally as shown in the printed invoice form 162 of FIG. 10. The cashiering form in FIG. 9 includes a heater 163 comprising Auction house logo, invoice number and current date. Customer identification fields 152 and 154 follow and are used to find a particular customer's invoice. Next is the listing of items 156 bought by that customer. This list is scrollable if more items exist than are visible in one window. Summary section 160 is provided on the bottom right of the screen, where the cashier will find the Amount Due that is to be reported to the customer. Final section 158 of the screen is used to record payments.

Payment section 158 contains a tab control with a tab for each payment type accepted by the auction house. For payment by a Credit Card, card information will be completed automatically from the customer information stored in the database, when available. Otherwise, the cashier must fill out this section. For payment by Check, the cashier must complete the check number and bank identification. On each tab, the cashier must fill out the amount paid by that method. More that one payment type can be used to pay an invoice. The total paid is displayed in bold font at the bottom of the payment section.

After filling out a customer ID, customer name or phone, the cashier selects a FIND button 164. The entries are used to find the customer in the database and to construct an Invoice from all of the items for which that customer was the high bidder. The invoice data are loaded into the cashier's invoice form. At this time, the cashier can verify the information with the customer and report the amount due to the customer. The invoice number can also be used for a FIND action, when searching for an existing invoice.

Next, the cashier receives payment from the customer and records it in the payment section of the form. Each payment type (other than cash) requires some additional information, such as the check or credit card number. The cashier enters this information for the payment type, along with the amount paid. The cashier will enter SAVE (button 165) to send this information to the database.

A PRINT button 166 is selected to print an invoice receipt for the customer. A CLEAR button 167 is selected to remove all data on the invoice form, leaving the form ready for the next customer. To remove an invoice entered erroneously, a DELETE button 168 is selected. Verification is required prior to the delete action being implemented, and will not delete the customer or high bid information. Searching for the customer again will rebuild the invoice. The cashier selects a CLOSE button 169 to shut down the cashiering window and return to the main Bidpath forum. Either the ENTER or TAB keys can be used to move to the next field on the form. The tab order will follow the natural flow of the fields on the form.

The automatic population of the invoice form makes cashiering quite fast. In the case of a customer using a credit card that has already been saved as part of the customer's registration information, only one field on the entire invoice form will need to be filled in to complete and close out the sale. A Payment Amount field 161 in the Credit Card tab of the payment section. The invoice form is also flexible, however, since the cashier can overwrite any of the fields.

Invoices are printed for the customer. The printed invoice mirrors the cashiering invoice form with unnecessary items removed, as indicated by the example of FIG. 10. The printed invoice comprises several sections. The first section is header 163 containing the auction house logo, as well as the invoice number and current date. Next, a Sold To section 144 is provided containing the customer ID (account number), customer name, and phone number. The majority of the invoice contains the itemized list of purchases. The bottom right of the first page always contains the purchase summary. This section is highlighted to call attention to the totals. To the left is the sale terms and total payment. If the number of items purchased does not fit on one page they will carry over to subsequent pages. “Continued on Page 2” will be printed at the bottom of page 1's Line Items. Again, the summary section will always appear on the first page.

The purpose of the DSU is to display the status of ongoing auctions at the onsite auction. The software of the present invention that drives the DSU:

Displays the status of ongoing auctions in a manner that spurs further bidding;

Allows the display of advertising;

Allows the display of informational announcements;

Enables multiple DSUs to display the same information or different information; and

Permit no DSUs to be present.

In order to make the concept of segment and auction scheduling accessible, a number of user interface abstractions have been adopted. The flow of items being sold at an auction is divided into auction segments. An auction segment is a group of items to be sold concurrently. An auction segment determines when an item goes on auction and when the auction is over. The possible conditions for starting an auction segment are:

A particular time;

After another segment; or

Manual Start.

The possible conditions for ending an auction segment are:

ManualEnd;

Time since last bid; or

Duration.

With these basic mechanisms, it is possible to schedule simultaneous auction segments and sequences of auction segments with the present invention. Since the primary onsite sales tool is the DSU, it is critical that the DSU be scheduled as efficiently as possible. In order to do this, the scheduling is controllable by the customer.

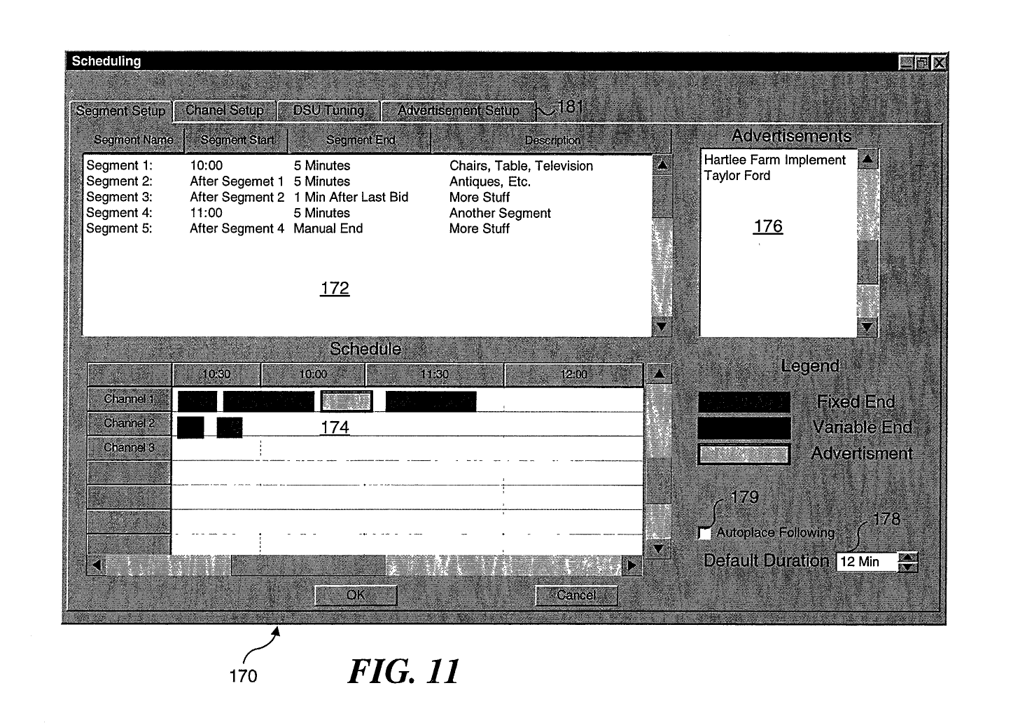

Balancing this requirement is the fact that the customer is not necessarily technically savvy. To help ease the introduction of this technology, the DSU scheduling is built around a television metaphor, as shown in an exemplary scheduling dialog box 170 of FIG. 11. A section 172 of this dialog box lists segment set up data, while a bar graph section 174 indicates the times at which specific channels will be active and uses color coding to indicate a fixed end, a variable end, and advertisements. Advertisements are optionally included in a block 176. A user is able to specify a default duration for switching between channels.

A DSU can be “tuned to” a particular channel (see FIG. 12). A DSU Channel comprises several programs, and a DSU program can be an auction segment, advertisement, etc. DSU programs, unlike real television, can run concurrently. When multiple programs are running concurrently, the DSU switches between the different programs at a user-configurable rate. A particular DSU can be tuned to more than one DSU Channel. In this case, the DSU will switch between the programs in all DSU Channels after the same user defined default time, as noted above.

The purpose of Segment Scheduling is to define when an item goes on sale and how the segment is closed. The purpose of DSU Scheduling is to define when particular items are shown on a DSU. The following sections detail the user interface for auctions and DSU scheduling. The scheduling is set up as a single tabbed interface where all the scheduling tasks can be accomplished. This interface is very powerful at the expense of some ease of use. To provide the quickest, easiest interface possible, two wizards are provided for use in setting up linear and silent auctions with a minimum of difficulty.

Segment Scheduling

The segments group box in section 172 of scheduling dialog box 170 (FIG. 11) contains a list of segments. The new and delete buttons allow the user to create and delete segments in section 182 of dialog box 180, which is illustrated in FIG. 12. The currently selected segment determines the content of all the other group boxes, and the Segment Contents group box contains controls that enable the user to add and remove items from the currently selected segment (not shown). The segment start group box contains controls (not shown) that enable the user to select the start time. The user must select either a manual start or a scheduled start. In the case of a scheduled start, the user can either select a “start time” or “start after another segment” or both. If both are selected, the segment will start after the segment listed, but not before the time selected. There are three options for ending the segment. In the case of a specific end time, the user must enter in the ending date and time. Ending after a delay ends the segment after there have been no bids for the specified period of time. A manual end enables the moderator to ends the segment manually. The resulting data are listed in the scheduling dialog box of FIG. 11.

The next tab after Segment Set up for dialog box 180 in FIG. 11 selects the channel building interface in which there is a list box containing the segments. Another list box contains the advertisements. The user can drag and drop items from advertisements list box 176 to the schedule box. When the first segment of a chain of segments is dropped onto a channel, the following segments are automatically placed if an “Autoplace Following” check box 179 is checked. An advertisement set up tab 181 enables a user to create and delete advertisements. It is assumed that these advertisements will take the form of an externally stored image or streaming media.

A Default Duration edit box 178 enables a user to enter an estimate for segments that end manually or after a delay, but does not affect the actual auction. The edit box enables a user to see a visual layout of the channels to help in the channel set up. The DSU list box (or tuning group box—not separately shown) contains a list of defined DSUs. A control inside the tuning group box enables the user to select the channels that the currently selected DSU receives. The purpose of the DSU is to display the status of ongoing auctions at the onsite auction.

As noted above, the abstractions adopted for the DSU make it easy for a non-technical user to program the DSU in much the same way they might program a VCR. A brief description of these abstractions is presented below.

An auction segment is a group of items to be sold concurrently. An auction segment can begin at a specified time, after a specified segment ends, or manually (i.e., the moderator's/bid caller's discretion). An auction segment can end after a specific duration, after a specified time since the last bid was placed, or manually.

An advertisement is a piece of stored image or streaming data. It can be used for “commercials” or any other form of public announcement an auction house wishes.

A program comprises either an auction segment or an advertisement (it is possible that other kinds of programs will be added at a later date). A segment begins and ends subject to the above bullet item. An advertisement is fitted between scheduled programming.

A channel comprises a sequence of programs. As mentioned above, these programs can be either auction segments or advertisements, much like a regular TV channel.

A DSU can be “tuned to” one or more channels.

The following sections detail the user interface for the DSU during an auction, assuming that the DSU has been tuned to one or more channels in advance by the auction house, and that each channel has been set up up with one or more programs. The DSU display is divided into the following three sections:

Logo Display

Main Display

Ticker Display

The overall layout of the Display and description of each of the display sections is provided below. Finally there is a brief discussion of how a DSU will behave when tuned to multiple channels.

The logo display section at locations 202 and 204, as shown in FIG. 14A, is for displaying two side-by-side company logos at the top of the display page. These spaces are reserved for Bidpath Corporation and any company that is a partner, for use of the DSU hardware. It is possible that more than two logos could be accommodated, as required. The main display section is the heart of the DSU display, because it is where the details of the currently running programs are displayed. If a DSU is tuned to a single channel, then the main display section is dedicated to displaying the currently running program from that channel, in the specified display mode. If the DSU is tuned to two or more channels, then the display will cycle between the channels, staying on each channel for the user-specified amount of time. Note that concurrently running programs from different channels need not have the same display mode.

There are many possible display modes for the main display section, depending on the nature of the data the auction house wishes to display. Initially, three display modes will be defined, but the system is designed to be completely extensible, in order to accommodate future requests for additional display modes by customers. In addition, while a user will be able to specify any display mode to be used for a particular segment, the DSU contains heuristics to choose a default mode, based on the nature of the segment (e.g., the number of lots in the segment, and the duration of the segment).

The three display modes are:

Multiple Listing Mode—Displays basic information on all lots that are part of the programs currently scheduled on the DSU. Examples of a dense multiple listing mode and detailed multiple listing mode are provided in FIGS. 14A and 14B, and 15A and 15B, respectively.

Hot List Mode—Displays basic information on the ten lots receiving the most bidding action among the current segment.

Single Item Mode—Displays detailed information on a specific lot from the currently scheduled programs, cycling through all of the lots sequentially. An example of this mode is provided in FIG. 16. A page 230 includes an image 232 of a bull dozer, a description of the item, and an indication of a top bid 234 and a second bid 236.

Each of these modes is described in detail in the following sections. The multiple listing mode displays information on all lots that are part of the program currently running on a DSU. For a DSU tuned to a single channel, the display would include all lots in the segment that is currently being auctioned. The display will accommodate roughly 20 items on a page, so segments containing more than 20 lots would be displayed on two or more pages, and the DSU will cycle between the pages, using a user-specified delay. The single item mode displays detailed information about a specific lot in the currently running program. For a DSU tuned to a specific channel, the display will cycle through each of the lots in the currently running segment, staying on each lot for the duration specified by the user. The display shows the following information about each lot:

Lot number;

Detailed description of the lot;

Picture(s) of the lot; and

Current top two bids, including bidder names and amounts.

The ticker display section displays all bids that come in for the programs currently scheduled on the DSU. The bids are displayed in the order in which they come in, and move across the display just like on a stock ticker. For the bid, the lot number of the item and the bid amount are displayed, separated by a dash. In addition, the last line of the ticker screen indicates when the currently displayed auction segment will be closing. It also indicates the page that is currently being displayed when multiple pages are being cycled through the display for the segment.

As mentioned above, a DSU can be tuned to multiple channels. In this case, it will “surf” between the channels, much like person might flip between TV channels with a remote control. The user specifies the channel switching frequency. Each channel can have a program running, which may be an advertisement or a segment. In the case of a segment, the display may be set to any of the modes discussed above: multiple listing, hot list, or single item. As the DSU switches between channels, the main display section can switch between the display modes. In addition, the display within a channel can be switching with a specified frequency, as in cycling between lots in a single item mode, or between several pages in a multiple listing mode.

The order and frequency of switching between multiple channels may need to be overridden under certain circumstances. One possible circumstance is when a segment is approaching its end. Another might be when a specific item is receiving a lot of bidding action. These overrides should be configurable by the user. Thus, a user might specify that a DSU be dedicated to a single segment when that segment is within two minutes of closing. In the case of several segments ending simultaneously, the DSU would have to switch back and forth between them, or perhaps, split the screen between them.

The Clerk User Interface Module

The clerk's job is to oversee the auction and keep an eye on the bidders, bid caller, and the ringmen. The clerk is very much focused on the present and wants to have very little, if any interaction with the software of the present invention. Thus, the present invention provides monitoring software to show the clerk the current status of the auction. The primary design goal is to put the bare minimum of items on the screen to make it intuitive and easy for the clerk to use.

The User Interface key abstractions in which the clerk is interested are:

The next item to be auctioned;

The current item being auctioned;

The item that was just sold;

The top current bidders; and

The overall schedule.

The clerk's focus will be on the immediate item to be sold next, item currently being auctioned, and the last item sold and the clerk will be interested in:

Common UI elements for all items;

Item number;

Name;

Picture;

Short Description; and

Appraised Value.

Additional user interface (UI) elements in the software for specific items that are of interest to the clerk are:

Next Item:

Item start;

Remove button; and

Manual Start button;

Current Item:

Item End;

Sold button;

Time since last bid;

Duration;

Ask Price; and

Bid Increment;

Last Sold Item:

Sold Price; and

Person to whom sold.

The clerk will be interested in who the high active bidders are on this item. UI elements related to the high active bidders include:

Bidder's name;

Bid amount; and

Bidder's deposit.

The clerk needs access to the overall schedule to determine how the auction is progressing. This schedule may need to be updated to reflect changes to the ongoing auction. The intention is that the clerk would flag items that need to be update, an administrator would take care of the actual updating.

UI elements in the software of the present invention include:

Item Name;

Start;

End;

Description of item; and

Summary information (Item n of Total).

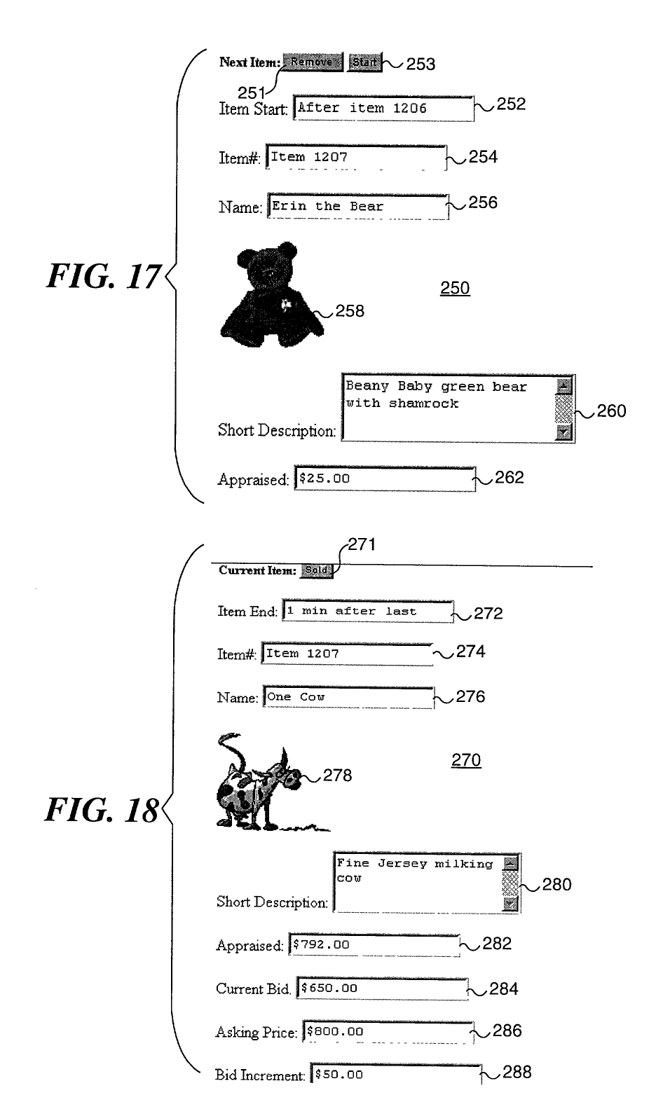

The following provides further detail of the UI for the Clerk Software module in the present invention, examples of which are shown in FIGS. 17, 18, and 19. FIG. 17 includes a UI 250 for the Next Item with the following elements:

A Remove Button 251—The remove button is used to remove an item from the schedule, which may be necessary in case the item has been damaged, stolen, lost etc. The clerk is only interested in getting this item out of the schedule and moving to the next. This item will get flagged and the administrator can worry about re-scheduling or dropping the item permanently.

A Start Button 253—The start button manually makes an item the current item. It will be necessary to ensure that the item currently in use has been resolved.

An Item Start Box 252—Item Start shows when an item is scheduled to become the current item. The options are:

A particular time;

After another item; and

Manual Start.

Item# box 254—The lot number assigned by the auction house.

A Name Box 256—The name of the item:

A Picture 258—A picture of the item;

A Short description Box 260—A short description of the item; and

An Appraised Value Box 262—The appraised value of the item.

FIG. 18 illustrates a UI 270 for the Current Item UI that includes the following elements:

A Sold Button 271—The Sold Button manually flags the current item as sold.

An Item End Box 272—Shows how long this item is to be actively bid on. The options are:

Manual End;

Time Since Last bid (displays a countdown); and

Duration (displays a countdown).

An Item# Box 274—The lot number assigned by the auction house.

A Name Box 276—The name of the item.

A Picture 278—A picture of the item.

A Short Description Box 280—A short description of the item.

An Appraised Value Box 282—The appraised value of the item.

A Current Bid Box 284—The highest bid currently accepted by the bid caller.

An Asking Price Box 286—The bid amount being requested by the auction caller, which is not necessarily the current bid amount plus the bid increment (e.g., a jump bid).

A Bid Increment Box 288—The bid increment for the current item (the Clerk can adjust the bid increment).

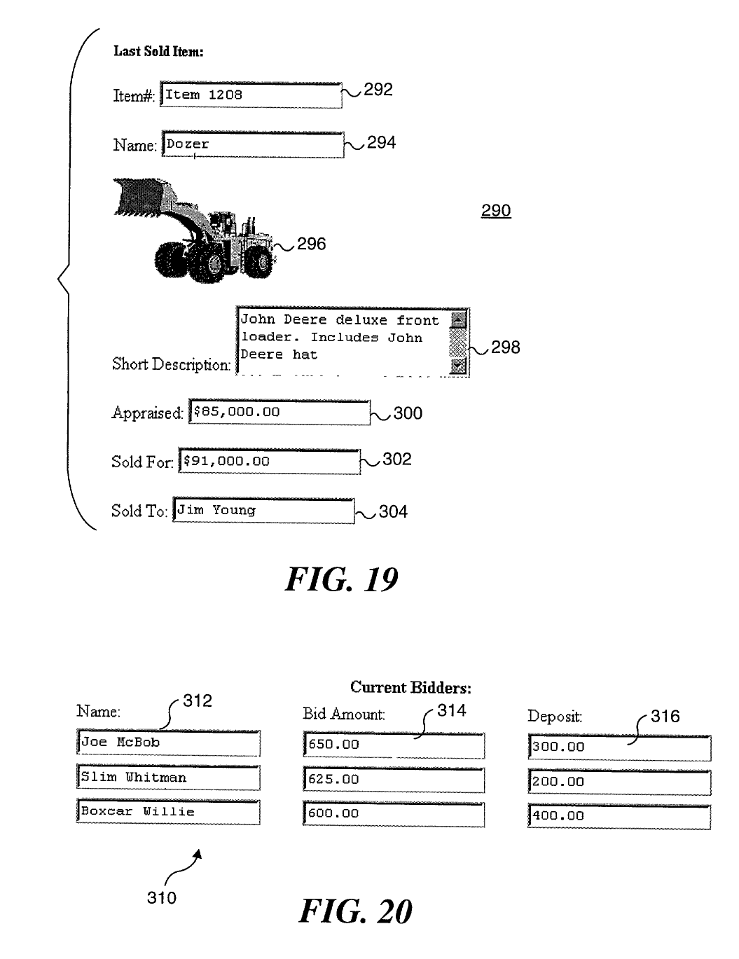

In FIG. 19, a UI 290 for the Last Sold Item includes the following elements:

An Item# Box 292—The lot number assigned by the auction house.

A Name Box 294—The name of the item.

A Picture 296—A picture of the item.

A Short Description Box 298—A short description of the item.

An Appraised Value Box 300—The appraised value of the item.

A Price Sold For Box 302—Amount of the winning bid.

A Person Sold to Box 304—Name (or other identification) of person who made the winning bid.

A table or grid 310 shows the current top three bidders, as indicated in FIG. 20. The table includes the following items:

A bidder Name 312;

A bid amount 314; and

A bidder's deposit 316.

Purpose of a display 320 illustrated in FIG. 21 is to give the clerk a read-only view of the overall schedule and also to show how many items have been sold thus far. This information is displayed in a grid or table format. Items are removed from the display as they are sold. The table includes the following Items:

An Item# 322;

An Item Name 324;

A Start Box 326;

An End Box 328; and

A Short Description Box 330.

During an ongoing auction, there are basic pieces of information that must be exchanged, as follows:

Bid Information, along with any proxy bid instructions;

Bidder Information as Needed;

Ask Price; and

Closing Information.

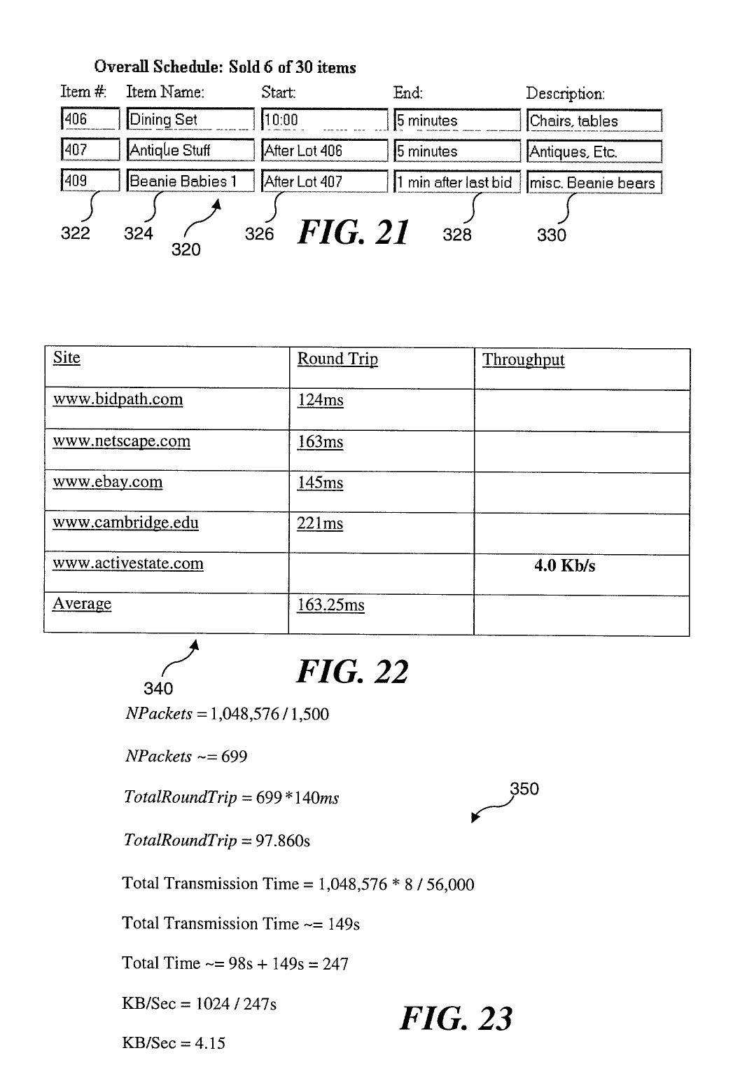

Latency is the measure of how long it takes a particular message to cause some action, and should not be confused with bandwidth, which is the amount of information that can flow though a system in a particular measure of time. Latency is important, because it is latency that the end user sees as a performance problem. With that fact in mind, the maximum amount of time that can pass between the time an Internet user submits a bid and time at which the bid is relayed to the DSU, Moderator, and Bid Caller stations is about two seconds. Initially, the bandwidth available between the CSU and the Internet site will be that of a V.90 modem. The typical round-trip times measured for this type of device are shown in a table 340 in FIG. 22.

By making several assumptions about the Transmission Control Protocol/Internet Protocol (TCP/IP), it is possible to derive some throughput estimates. First, assume that a packet contains a maximum of 1,500 bytes of usable data. Second, assume that every packet must be acknowledged before the next packet is sent. Third, assume that the packets are transmitted at the maximum throughput of the model, 56 Kbps. The throughput is determined as shown by an algorithm 350 in FIG. 23. This example is a simplification that does not consider a number of details, but it serves to illustrate a result that is close to the actual measured throughput, for the parameters that were assumed.

If a bid consists of 200 bytes, the round-trip time for transmission of the bid would be about 163 ms and the transmit time would be about 28 ms, for a total of 191 ms. Thus, the transmit time is relatively small in comparison to the round-trip latency required for the packet. Based on this latency, only about five bids/second can be transmitted.

There are two ways to overcome the problem caused by the round-trip delay. The first option is to produce a batch of multiple bids combined into a single packet of information and amortize the round-trip costs over these multiple bids. If a 1,500 byte packet is filled with the required information, about seven bids can be included in a single packet. Given a round-trip time of 163 ms and a transmission time of 214 ms, for a total of 377 ms, about 18 bids/second can be transmitted, providing an average bid transmission time of about 53 ms—a substantial improvement over a single bid per packet scheme in which each bid requires about 191 ms to transmit.

The one drawback to the above-described solution is that in order to fill a packet, the packet must be held until it is full, before the packet can be transmitted. Thus, the first bid waits longer than the rest of the bids in the packet. If a full packet can be transmitted and confirmed in 377 ms, if 18 bids/second are being transmitted, and assuming that the bids are evenly spaced in time, a new bid arrives every 56 ms, on average. The first bid must wait 336 ms for the remaining 6 bids in the packet to be completed, before it is transmitted The first packet would therefore require 713 ms before it was ready for processing, while the last packet would require about 377 ms before it was ready for processing. Thus, the average latency is 545 ms from the time that a packet is submitted until it is confirmed as being received at the CSU.

From the preceding, it will be evident that, at the expense of about 354 ms per bid, the preceding technique of collecting bids in packets increases the efficiency of their transmittal and processing over that of transmitting and processing a single bid by about 3.5 times. The average round-trip time for processing bids transmitted from a test site with a 32-byte packet is 183 ms, and the average for a 1500-byte packet is 217 ms.

The alternative to using larger packets that each contain multiple bids is to incur the round-trip penalty concurrently by using multiple threads that are written with multiple TCP/IP connections to a DSU. Assuming that the entire round-trip delay can be taken concurrently, a single V.90 connection could support at most 35 bids/second using 35 threads and 35 open connections per CSU, apparently almost doubling the expected throughput from 18 bids/second to 35 bids/second.

Unfortunately, the solution to this problem is not that simple. Transmitting too many threads at one time to a server can dramatically impact its performance. Generally, it appears that transmitting 20 threads per server processor at one time is about the maximum before the performance of the server and system starts to decline. While this task could be spread over multiple servers on the Internet side at some expense in hardware, it is not a viable solution in the CSU.

The conclusion drawn from this discussion and the testing that has been carried out is that it is imperative that multiple bids be packaged in a single message. It is not nearly as important that the message fit into a single packet because the TCP sliding window acknowledgement protocol actually can cause all but the last acknowledgement to happen concurrently with the transmission of data.

TCP is built with the round-trip latency problem in mind. It uses a scheme called “sliding windows.” The basic idea is that a packet of information can be sent while a previous transmitted packet is still in transit, so that the first three or four packets may have been transmitted by the sender before the first packet is acknowledged by the receiver. TCP only has to wait the entire round-trip time for the last packet transmitted to be acknowledged. As a matter of fact, simply filling one packet is substantially worse than a sliding window acknowledgement. It has been noted by others that use of a non-sliding window type of protocol wastes substantial network bandwidth; a new packet cannot be sent until an acknowledgment for the previous packet has been received. This point is especially true over a network with potentially high round-trip times.

Overall, there is a trade off between bandwidth utilization and latency. Based on experience, it is assumed that the database system employed for the present invention will provide suitable access times and throughput. However, should it be necessary to augment the database system with a low-latency, high-throughput system, there are a number of options available. The worst case scenario would require building a fast data distribution system using commercial implementations of Message Passing Interface (MPI), which is at the heart of many of the current generation of “Commodity Supercomputers.” The details of MPI are not important for this discussion. MPI is a worst case alternative in terms of development effort required. There are more appealing and quicker-to-market alternatives. As pointed out in the above section on TCP/IP performance, there is a trade off with respect to throughput versus latency. In general, an adaptive approach is preferred. The system employed in the present invention should synchronize bids and status information as often as required by the latency constraints, but no more often.

Even on a dedicated telephone line, it is unreasonable to expect that a CSU would be able to open a connection with a Bidpath server and have that connection stay active all day. Since it is impractical to count on a single connection, it is critical that the CSU be able to make and break connection over the course of the day. It is desirable to have a connection stay active as long as possible to mitigate the connection set up/tear down costs and to avoid TCP/IP slow starts as much as possible. One possible solution is HTTP-KeepAlive, which is new to HTTP 1.1, but is implemented in IIS 4.0.

The best solution to these design constraints is to provide an adaptive communication mechanism that is primarily controlled by the onsite system employed. In broad terms, the Internet site holds messages for later pickup by the onsite system over a standard HTTP connection. When the onsite system retrieves the messages, it monitors the performance of the connection. On the following retrieval, the performance metrics are transmitted back to the Internet site, which uses these metrics to prioritize messages. In addition to the prioritization of messages on the Internet side, the onsite system uses the same metrics to vary the frequency of updates. By providing an adaptive mechanism such as this, the Bid Forum system is able to ensure that high priority messages, like bids on items that are about to close, are transmitted first over busy connections. Obviously, a prioritization scheme can only accomplish so much on its own. The most interesting property of this system is that, as a communication link becomes more congested, there is a greater opportunity for the Internet system to reduce the amount of data being sent. If there are 100 bids on an item in one second, only the best two or three (highest) need to be sent to the onsite system.

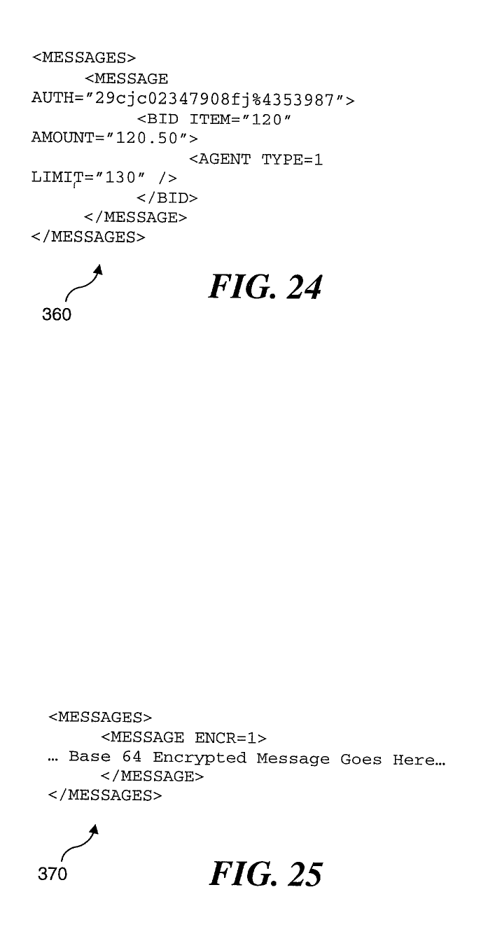

All messages are transmitted in XML format. It is believed that the extra overhead required to do so is minimal over a modem that does data compression, such as is done by all V.90 modems, with the added benefit of enabling business-to-business (B2B) auctions. The onsite system periodically requests messages from the Internet system over HTTP. The site request includes the HTTP KeepAlive option to help reduce the repeated connection set up and tear down times. All messages are contained in an envelope. All the envelopes are wrapped in an outer XML tag to preserve the well-formed structure of the XML. An example of an XML message envelope 360 is shown in FIG. 24.

Message envelopes contain an authenticity attribute that is a digital signature. The Internet Site and the onsite system hold the keys for the digital signatures. It would be a mistake to require that a user have a public/private key pair in order to trade on the system, because doing so might add a significant barrier to use. The authentication is simply authenticating that the message came from the machine or computing device that claims to have sent it. The vast majority of messages need to be authenticated, but not encrypted. Messages that are encrypted are represented by an example 370 shown in FIG. 25.

There are two major motivations behind not using HTTP for transmitting bid messages. First, since most of the messages do not require encryption, it adds extra overhead that is not needed. Second, encryption tends to defeat data compression algorithms, including the algorithm used in modems.

XML Document Type Definition

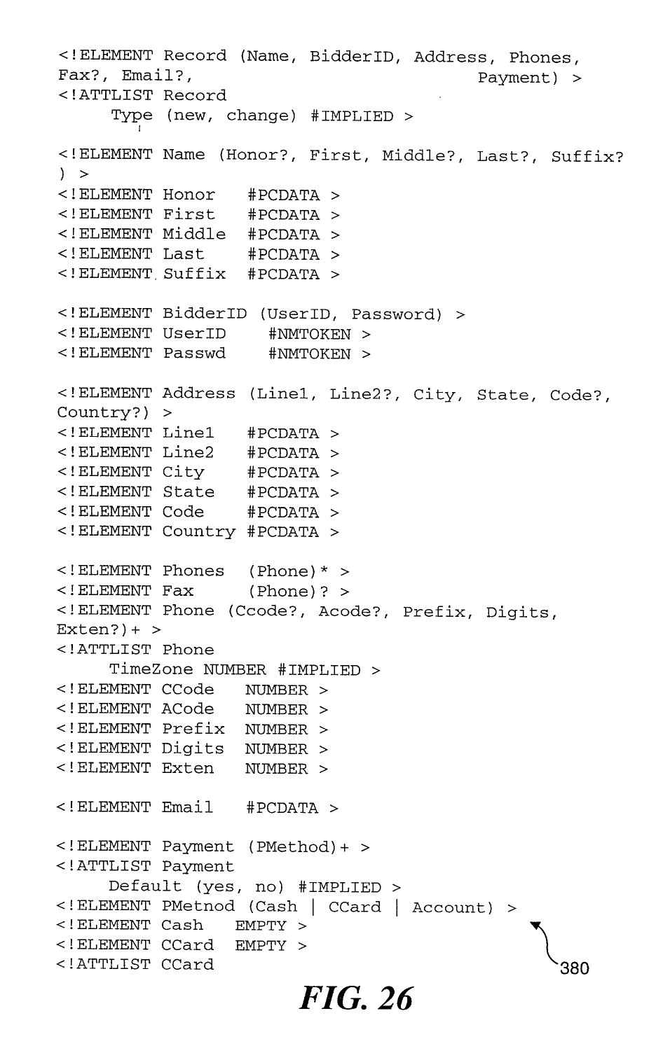

This section describes the XML document type definitions (DTDs) for user registration, user login, and bidding during an auction. The DTD defines the structure of the message data to be transferred, and an example 380 is illustrated in FIG. 26. This DTD defines a document that prospective bidders can use to apply for registered status. Registered status will be required for bidding on any auction items, although unregistered visitors can view auctions. The definition provides for changes to existing data as well.

In the case of a previously unregistered bidder, the bidder name and password will be validated; they will only be accepted if the requested UserID has not already been chosen by another bidder. Otherwise, the response will indicate that the UserID is already in use and will require re-submission of the form with a different choice. An alternative may even be suggested. In the case of a currently registered bidder, the bidder name and password will be taken as confirmation of the changes contained in this document. Any provided information will be used to update the current record in accord with the rules noted above. When a registered bidder first accesses an ongoing auction session from a browser, the bidder must log on so that the system will recognize him/her. This requirement enables the system to assign the bidder a short ID number that will subsequently represent the person in all bidding, reducing the amount of data traffic that is required. To log in, the bidder must already be known to the system, based on data entered in a previous registration.

A recognized bidder can place a bid on any item by sending the server just a few numeric identifiers and values. A bid document is potentially a collection of several bids, up to the number that will fit into the packet size of the underlying data transport protocol, as described above. Both the packet and each bid in the packet will be time stamped. It has been determined that the following development standards will preferably be used, subject to changes that may subsequently occur.

Server Operating System: Microsoft Corporation's Windows NT 4.0™ or Windows 2000™ operating system;

Web Server: IIS 4.0™ or later;

Database Server: Microsoft Corporation's SQL Server 7.0™ or later;

Middle Tier Platform: MTS 2.0™ or later;

Preferred Middle Tier Language: Microsoft Corporation's Visual Basic 6.0™ or later;

Alternate Language: Microsoft Corporation's Visual C++6.0™ or later (a less preferred alternative); and

XML Parser: Microsoft Corporation's XML Parser™.

All database access with the exception of ad-hoc reporting requirements will be carried out through SQL Server 7.0™ (or later) stored procedures. There are a set of metadata-driven stored procedures for single-table operations. All operations that are single-table operations should go through these stored procedures.

Custom stored procedures may be created where performance is a consideration or the existing stored procedures do not have the required functionality. All database objects are preferably stored in a single database called “Bidpath.”

All business logic will be contained in the business layer, which is implemented as one or more MTS objects. These objects are required to be stateless and are required to properly use the IObjectContext.SetComplete( ) and SetAborto( ) methods. IObjectContext.DisableCommit( ) and IObjectContext.EnableCommit( ) should not be used.

Internet access to the business layer will be provided via XML over HTTP or HTTPS. For this project, an active server page (ASP) page should be created that takes an HTTP request in XML form that corresponds to each method available from the business logic. The XML requests and responses are required to be well-formed but are not required to be validated.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for integrating online bidding over a communications network and onsite bidding at a location where an auction is being held, without requiring transmission of streaming video or audio data to online bidders from the location, comprising the steps of:
(a) providing a database that includes information about items being auctioned;
(b) enabling prospective bidders who are online to access the database over the communications network prior to entering a bid;
(c) communicating bidding information to and from:
(i) bidders who are onsite at the location of the auction; and
(ii) bidders who are online, over the communication network;
(d) enabling bidders who are online to transmit bids to the onsite auction over the communications network;
(e) automatically determining a highest bid from among each bid transmitted over the communication network by bidders who are online; and
(f) determining a purchaser of an item being auctioned based upon a highest bid made by a bidder who is either onsite or online.

2. The method of claim 1, wherein the bidding information includes at least one of an identification of the item currently being auctioned, an identification of any current highest bidder, an indication of any current highest bid amount, and an asking bid amount.

3. The method of claim 1, wherein bids submitted by bidders who are online each include a bid amount, and an identification of the bidder who is making the bid.

4. The method of claim 1, further comprising the step of displaying at the location of the auction the current highest bid and an identification of a highest bidder, who is either online or onsite.

5. The method of claim 1, further comprising the step of enabling pre-registration of bidders who are online.

6. The method of claim 1, further comprising the step of enabling bidders who are onsite to register a bid for an item electronically.

7. The method of claim 1, wherein the step of communicating bidding information comprises the step of transmitting packetized data over the communication network.

8. The method of claim 1, further comprising the step of enabling bidders who are online to participate in one or more of a plurality of auctions occurring on different channels accessible over the communication network, each channel being associated with a different set of items to be auctioned.

9. The method of claim 1, further comprising the step of providing a plurality of auction administrative functions in software used to integrate online bidding and onsite bidding, said plurality of auction administrative functions including at least one of:
(a) registering bidding participants in an auction;
(b) providing invoicing statements identifying each item purchased by a successful bidder in one or more auctions, costs associated with the purchase of each item, any adjustment to the costs, and a total amount due;
(c) accumulating data regarding bidders and items sold at an auction; and
(d) providing advertising that is displayed to bidders who are online.
